(19) United States
(12) Patent Application Publication
(10) Pub. No.: US 2007/0126586 A1
(43) Pub. Date: Jun. 7, 2007

(54) Wireless tag adjusting method, wireless tag adjusting system, and wireless tag

(76) Inventor: Yoshimitsu Ohtaka, Sunto-gun (JP)

Correspondence Address: HARNESS, DICKEY & PIERCE, P.L.C., P.O. BOX 828, BLOOMFIELD HILLS, MI, 48303, US

(21) Appl. No.: 11/607,137

(22) Filed: Nov. 30, 2006

(30) Foreign Application Priority Data
Dec. 1, 2005 (JP) 2005-348099

(51) Int. Cl. G08B 13/14; H04Q 5/22; H01Q 9/00

(52) U.S. Cl. 340/572.7; 340/10.1; 343/750

(57) ABSTRACT

A wireless tag adjusting method comprising measuring a communication characteristic by performing wireless communication with a wireless tag having an antenna and an integrated circuit connected to the antenna, calculating an antenna adjustment pattern on the basis of the measured communication characteristic, and forming an adjustment pattern by one of or a combination of ejecting of a dielectric material, ejecting of a magnetic material, and ejecting of a conductive material by using an ink jet printer on and/or around the antenna in the wireless tag in accordance with the calculated antenna adjustment pattern, thereby adjusting the antenna in the wireless tag.

### CROSS-REFERENCE TO RELATED APPLICATIONS

This application is based upon and claims the benefit of priority from prior Japanese Patent Application No. 2005-348099, filed Dec. 1, 2005, the entire contents of which are incorporated herein by reference.

### BACKGROUND OF THE INVENTION

1. Field of the Invention

This disclosure relates to a wireless tag adjusting method, a wireless tag adjusting system, and a wireless tag.

2. Description of the Related Art

Hitherto, in a wireless tag having an antenna and a wireless IC chip connected to the antenna, it is pointed out that when matching between input impedance of the wireless IC chip and the impedance of the antenna is imperfect, high-frequency current is reflected at the junction point of the antenna and the wireless IC chip, energy for the wireless IC chip to operate cannot be sufficiently supplied to the wireless IC chip and, as a result, the communication distance becomes shorter.

On the other hand, another technique is known such that an impedance matching circuit is formed in an antenna of a wireless tag. Specifically, a technique is disclosed in, for example, Jpn. Pat. Appln. KOKAI Publication No. 2005-167813 that a slit having optimized width and length is formed in the antenna, and a wireless IC chip is connected to a terminal portion of the slit, thereby matching an input impedance of the wireless IC chip and the antenna impedance.

In the wireless tag, at the time of connecting the wireless IC chip to the antenna, variations in the input impedance of the wireless IC chip occur depending on a connecting method, a connection material, or the like. Consequently, a method of connecting a slit whose shape is fixed to the wireless IC chip cannot cope with a change in the input impedance of the wireless IC chip in the connection part, and it is difficult to make the input impedance match with the antenna impedance. To address the problem, for example, as disclosed in Jpn. Pat. Appln. KOKAI Publication No. 2004-127230, a technique is known such that a conductor part of the antenna at the end of a slit is removed by a laser beam machine in a state where an antenna and a wireless IC chip are connected and mounted. By increasing the length of the slit, the antenna impedance is adjusted.

For example, as disclosed in Jpn. Pat. Appln. KOKAI Publication No. 2005-165462, a configuration of sandwiching a wireless tag by a dielectric cover having predetermined permittivity is known. Specifically, the wavelength around an antenna is shortened by the wavelength shortening effect produced by the dielectric cover. Consequently, by preliminarily forming an antenna having a length matching the half wavelength of the shortened wavelength, a resonant condition is obtained, and the maximum power can be used effectively. Even when various external dielectrics come close to a wireless tag, since the wireless tag is sandwiched by the dielectric cover having constant permittivity, the influence of the external dielectric is small. Most of the wavelength shortening effect is produced by the dielectric cover, and the resonant condition can be maintained.

As disclosed in, for example, Jpn. Pat. Appln. KOKAI Publication No. 2002-222398, it is also known that the propagation speed of electromagnetic waves around the antenna of a wireless tag changes due to the influence of the dielectric or magnetic material around the wireless tag, and the wavelength shortening effect is produced.

However, as in the technique disclosed in Jpn. Pat. Appln. KOKAI Publication No. 2005-167813, in a method of obtaining matching between input impedance of a wireless IC chip and the impedance of an antenna by adjusting the length of a slit by using a laser beam machine after mounting of the wireless IC chip, an expensive machine such as the laser beam machine has to be used. In addition, the processing work is troublesome. In eliminating process performed by the laser beam machine, the conductor in the slit is removed. Once the conductor is removed, it cannot be reversed.

The dielectric or magnetic material around the wireless tag exerts an influence not only on the antenna length by shortening of the wavelength but also on the antenna impedance and the input impedance of the wireless IC chip. To reduce the influence of the dielectric or magnetic material around the wireless tag, a dielectric cover as described in Jpn. Pat. Appln. KOKAI Publication No. 2005-165462 is effective. However, in reality, a thick dielectric cover or a material having high permittivity is required.

However, the thick dielectric cover limits the use of an object to which the wireless tag is adhered and causes a problem of peeling of the adhered wireless tag. Consequently, the dielectric cover cannot be formed so thick. When a material having high permittivity is used, in some cases, the energy of electromagnetic waves is lost due to dielectric loss. Particularly, the dielectric cover having high permittivity cannot be disposed in the propagation direction of radio waves for the reason that the influence of the dielectric loss increases.

It is difficult to manage variations in the permittivity and permeability of an object to which a wireless tag is adhered, even if a product is manufactured by mass production with determined specifications other than an industrial product such as an electronic part. In particular, it is extremely difficult to manage the permittivity and permeability at the time of production of daily-use articles, food, clothing or the like except for special cases. When an object to which a wireless tag is adhered is perishable food, the permittivity and permeability of all of objects are different from each other. The permittivity and permeability of a mail and a small packet also vary among objects to which wireless tags are adhered due to variations in the contents and packages. As described above, the permittivity and permeability of an object cannot be predicated in advance. Therefore, it is difficult to manufacture a wireless tag having an antenna length and antenna impedance matching an object in advance.

Variations in the permittivity and permeability of the periphery of the wireless tag are influenced not only by the physical property values of an object to which a wireless tag is adhered but also by variations in the shape of the object and, further, deformation and distortion of the wireless tag at the time of adhesion.

### BRIEF SUMMARY OF THE INVENTION

An aspect of the invention is; A wireless tag adjusting method comprising: measuring a communication characteristic by performing wireless communication with a wireless tag having an antenna and an integrated circuit connected to the antenna; calculating an antenna adjustment pattern on the basis of the measured communication characteristic; and forming an adjustment pattern by one of or a combination of ejecting of a dielectric material, ejecting of a magnetic material, and ejecting of a conductive material by using an ink jet printer on and/or around the antenna in the wireless tag in accordance with the calculated antenna adjustment pattern, thereby adjusting the antenna in the wireless tag.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the detailed description of the embodiments given below, serve to explain the principles of the invention.

FIG. 1A is a plan view showing a basic configuration of a wireless tag according to a first embodiment of the invention;

FIG. 1B is a side view showing a basic configuration of the wireless tag according to the first embodiment of the invention;

FIG. 2 is a partly-sectional side view showing a modification in which a protection layer is formed on the wireless tag in the first embodiment;

FIG. 3A is a plan view showing a state where a magnetic pattern, a dielectric pattern, and a wavelength shortening layer pattern are formed on the wireless tag in the first embodiment;

FIG. 3B is a cross section taken along line A-A of FIG. 3A;

FIG. 4 is a cross section showing a modification in which a protection layer is formed on the wireless tag in FIGS. 3A and 3B;

FIG. 5 is a perspective view showing a state where the wireless tag is attached to an object to be recognized in the embodiment;

FIG. 6 is a plan view showing a modification of a wavelength shortening material ejecting planned portion which is assumed in the wireless tag in the embodiment;

FIG. 7A is a plan view showing a state where a magnetic pattern, a dielectric pattern, and a wavelength shortening layer pattern are formed on the modification of FIG. 6;

FIG. 7B is a cross section taken along line B-B of FIG. 7A;

FIG. 8 is a perspective view showing the configuration of a wireless tag adjusting system used in the embodiment;

FIG. 9 is a block diagram showing a control configuration of the wireless tag adjusting system;

FIG. 10 is a flowchart showing an antenna adjustment basic algorithm executed by a control computer of the wireless tag adjusting system;

FIG. 11 is a flowchart showing internal processes of an adjustment pattern calculating step in the antenna adjustment basic algorithm of FIG. 10;

FIG. 12 is a flowchart showing internal processes of an impedance matching adjustment pattern calculating process in the adjustment pattern calculating step in FIG. 11;

FIG. 13 is a flowchart showing internal processes of an antenna resonance adjustment pattern calculating process in the adjustment pattern calculating step in FIG. 11;

FIG. 14 is a plan view showing a basic configuration of a wireless tag according to a second embodiment of the invention;

FIG. 15A is a partially-enlarged plan view showing a first stage when an antenna is extended by an antenna extension conductor pattern in the second embodiment;

FIG. 15B is a cross section taken along line E1-E1 of FIG. 15A;

FIG. 16A is a partially-enlarged plan view showing a second stage when the antenna is extended by the antenna extension conductor pattern in the second embodiment;

FIG. 16B is a cross section taken along line E2-E2 of FIG. 16A;

FIG. 17A is a partially-enlarged plan view showing a third stage when the antenna is extended by the antenna extension conductor pattern in the second embodiment;

FIG. 17B is a cross section taken along line E3-E3 of FIG. 17A;

FIG. 18 is a plan view showing a basic configuration of a wireless tag according to a third embodiment of the invention;

FIG. 19A is a partially-enlarged plan view showing a first stage when the antenna is extended by an antenna extension conductor patch in the third embodiment;

FIG. 19B is a cross section taken along line G1-G1 of FIG. 19A;

FIG. 20A is a partially-enlarged plan view showing a second stage when the antenna is extended by an antenna extension conductor patch in the third embodiment;

FIG. 20B is a cross section taken along line G2-G2 of FIG. 20A;

FIG. 21A is a partially-enlarged plan view showing a third stage when the antenna is extended by an antenna extension conductor patch in the third embodiment;

FIG. 21B is a cross section taken along line G3-G3 of FIG. 21A;

FIG. 22A is a partially-enlarged plan view showing an initial state when the antenna is shortened by an antenna shortening conductor patch according to a fourth embodiment of the invention;

FIG. 22B is a diagram showing a first stage when the antenna is shortened by the antenna shortening conductor patch according to the fourth embodiment of the invention;

FIG. 23A is a partially-enlarged plan view showing a second stage when the antenna is shortened by the antenna shortening conductor patch according to a fourth embodiment of the invention;

FIG. 23B is a diagram showing a third stage when the antenna is shortened by the antenna shortening conductor patch according to a fourth embodiment of the invention;

FIG. 24A is a partially-enlarged plan view showing an initial state when the antenna length is changed by an antenna length changing conductor patch according to a fifth embodiment of the invention;

FIG. 24B is a diagram showing a first stage when the antenna length is changed by the antenna length changing conductor patch according to the fifth embodiment of the invention;

FIG. 24C is a diagram showing a second stage when the antenna length is changed by the antenna length changing conductor patch according to the fifth embodiment of the invention;

FIG. 25A is a partially-enlarged plan view showing an initial state when a slit in a wireless tag according to a sixth embodiment of the invention is deformed by a slit deforming conductor patch;

FIG. 25B is a partially-enlarged plan view showing a first stage when a slit in the wireless tag according to the sixth embodiment of the invention is deformed by the slit deforming conductor patch; and

FIG. 25C is a partially-enlarged plan view showing a second stage when a slit in the wireless tag according to the sixth embodiment of the invention is deformed by the slit deforming conductor patch.

### DETAILED DESCRIPTION OF THE INVENTION

Embodiments of the present invention will be described hereinbelow with reference to the drawings.

### FIRST EMBODIMENT

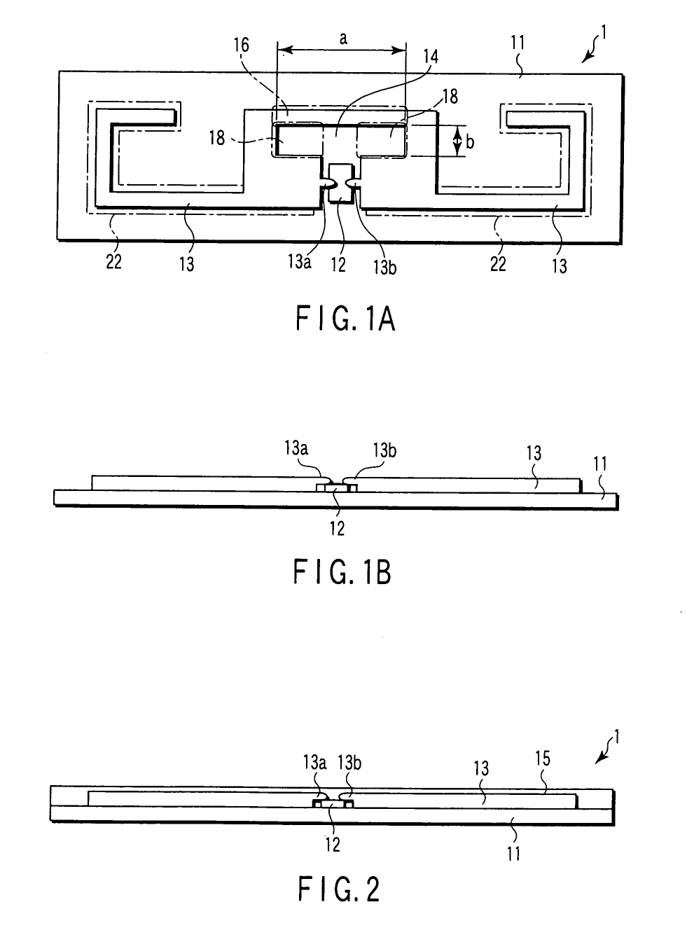

FIGS. 1A and 1B are diagrams showing a basic configuration of a wireless tag 1. As shown in FIGS. 1A and 1B, a wireless IC chip 12 is disposed in the center of a substrate 11. An antenna 13 made by a conductor pattern is provided around the wireless IC chip 12 and extending to the right and left sides.

In the antenna 13, a slit 14 is formed as an impedance matching circuit near the wireless IC chip 12. The wireless IC chip 12 is an integrated circuit having various circuits for recognizing an object to be recognized, writing/reading information, and the like wirelessly and is connected by two right and left parts to the antenna 13 via connecting parts 13a and 13b.

The substrate 11 is constructed by a flexible film made of polyethylene, polyethylene terephthalate (PET), polypropylene, polyimide, or the like. In place of the flexible film, a high polymer material such as polypropylene, polycarbonate, POM, PMMA, or the like or a rigid substrate made of glass epoxy, paper phenol, glass, ceramics, or the like may be used. A compound containing, as an element, barium, titanium, silicon, or the like having high permittivity, a material containing particles of the compound as particles, or a material containing particles of a magnetic material such as ferrite having high magnetic permeability can be also used.

In the wireless tag 1, as shown in FIG. 2, a protection layer 15 made of the same material as that of the substrate 11 or a similar material may be provided over the substrate 11 to prevent peeling and destruction due to contact with the wireless IC chip 12, the antenna 13, and the connecting parts 13a and 13b. The protection layer 15 may be formed by coating, a film, or being sandwiched by a rigid material. Further, the protection layer 15 may be formed by, for example, ejecting a high polymer material or the like by an ink jet apparatus or the like.

The antenna 13 can be formed by, for example, metal stamping using aluminum, stainless steel, or the like, or etching. To cope with various antenna patterns, a conductor pattern formation by an ink jet printing apparatus is used. The method includes a method of forming a circuit pattern by ejecting a solution containing metal particles onto the substrate 11 by an ink jet printer and a method of forming a circuit pattern by ejecting a solution containing a catalyst for electroless plating onto the substrate 11 by an ink jet printer.

In the method using a solution containing metal particles, a solution containing particles whose component is platinum, gold, silver, copper, or the like is ejected in an antenna pattern shape on the substrate 11 by the ink jet printer, and then bringing the solution into conduction by heating at 100 to 250° C., thereby forming a conductor pattern of the antenna 13.

In the method using a solution containing a catalyst for electroless plating, a catalyst solution containing palladium, silver, or the like is ejected in an antenna pattern shape on the substrate 11 by the ink jet printer, making the solvent transpire by heating at 100 to 250° C., and soaking the substrate 11 on which the antenna pattern is formed in an electroless plating solution of copper, nickel, or the like, thereby forming the conductor pattern of the antenna 13 by electroless plating.

Further, the antenna 13 can be also formed by ejecting a conductive polymer (polyaniline, polypyrrole, polythiophene, polyisothianaphthene, polyethylene dioxithiophene, or the like) by the ink jet printer.

For the connecting parts 13a and 13b, wire bonding or the like is used. The connecting parts 13a and 13b can be also formed by the conductor pattern forming method using the ink jet printer.

Although the case of using the wireless IC chip 12 as an integrated circuit formed on a silicon wafer by the semiconductor process will be described as an example of the integrated circuit, alternatively, for example, an integrated circuit in which a semiconductor or wiring pattern or the like formed on the substrate 11 by an ink jet printer may be used.

The wireless tag 1 formed as described above is used by the bottom face of the substrate 11 of the wireless tag 1 is adhered to the surface of an object 21 to be recognized as an article such as a commercial product as shown in FIG. 5. It is also possible to regard the surface of the object 21 to be recognized as the surface of the substrate and form the wireless IC chip 12, the antenna 13, and the connecting parts 13a and 13b directly on the object 21 to be recognized. In this case, to form the antenna 13, a heating process or a process of soaking in a plating solution is necessary. Consequently, the surface material of the object 21 to be recognized is limited to, for example, the same material as that of the substrate 11. Alternatively, the wireless tag 1 can be formed by forming a smoothed layer made of a high polymer material or the like by, for example, ejecting a high polymer material by an ink jet printer so that the wireless tag 1 can be easily formed on the surface of the object 21 to be recognized and forming the wireless IC chip 12, the antenna 13, and the like on the smoothed layer.

Next, impedance mismatching in the wireless tag 1 will be described.

When the antenna 13 of the wireless tag 1 is irradiated with electromagnetic waves of used frequency of the wireless IC tag, high frequency current flows in the antenna 13. When matching between the input impedance of the wireless IC chip 12 and the impedance of the antenna 13 is imperfect, high frequency current is reflected by the connecting parts 13a and 13b, and the energy sufficient to operate the wireless IC chip 12 is not supplied. Consequently, the intensity of a signal input to the wireless IC chip 12 becomes weak and, as a result, wireless IC tag communication distance becomes short.

The causes of the mismatching of impedance are as follows. One of the causes is variation in the input impedance of the wireless IC chip 12 itself in accordance with semiconductor process conditions or the like. The variation can be measured before the wireless IC chip 12 is mounted in the wireless tag antenna 13. Therefore, to match the input impedance of the wireless IC chip 12 and the impedance of the antenna 13, at the time of forming the pattern of the antenna 13, the slit 14 can be formed so that its shape matches the shape of the antenna 13.

At the time of connecting the wireless IC chip 12 to the wireless tag antenna 13, the input impedance of the wireless IC chip 12 varies depending on the connecting method, the connection materials, and the like. The method of connecting the antenna 13 having the slit 14 of the fixed shape to the wireless IC chip 12 cannot address a change in the input impedance of the wireless IC chip 12 in the connection part. It is difficult to make the input impedance match the impedance of the antenna 13.

In the case where the wireless tag 1 is adhered to the surface of the object 21 to be recognized as shown in FIG. 5, if the object 21 to be recognized around the wireless tag 1 includes a dielectric or magnetic material, the wavelength shortening effect is exerted on the used frequency of the wireless tag 1. As a result, even if the impedance of the antenna 13 and the input impedance of the wireless IC chip 12 match each other before the wireless tag 1 is adhered to the object 21 to be recognized, there is a case such that the impedances do not match due to adhesion of the wireless tag 1 to the object 21 to be recognized.

Therefore, to make the impedance of the antenna 13 and the input impedance of the wireless IC chip 12 match each other, impedance matching has to be performed in an actual use state such as a state where the wireless tag 1 is adhered to the surface of the object 21 to be recognized or a state where the wireless tag 1 is directly formed on the surface of the object 21 to be recognized. Average values of the impedance of the antenna 13 and the input impedance of the wireless IC chip 12 in the actual use state can be obtained by simulation or from statistic data, and an initial pattern of the antenna 13 is determined from the average values. Based on the initial pattern, a conductor pattern is formed.

As a result, in the initial pattern of the antenna 13 based on the average values, in each of the wireless tags 1 in the actual use, the impedance of the antenna 13 and the input impedance of the wireless IC chip 12 are mismatched. Therefore, by employing the method of using the initial pattern of the antenna 13 based on the average values and finely adjusting the impedance of the antenna 13 of each of the wireless tags 1 in the actual use state in which the wireless tag 1 is adhered to the object 21 to be recognized, accurate impedance matching can be obtained.

The method of matching impedances in the actual use state in which the wireless tag 1 is adhered to the object 21 to be recognized will be described below.

On the basis of average values of the impedance of the antenna 13 and the input impedance of the wireless IC chip 12 in the actual use state, the slit 14 having a length “a” and a width “b” as an impedance matching circuit is provided on the antenna 13. By adjusting the slit 14 and the state of the periphery of the slit 14, the input impedance of the wireless IC chip 12 and the impedance of the antenna 13 are matched. By the operation, the high frequency current flowing in the antenna 13 can be supplied to the wireless IC chip 12 without a waste.

The slit 14 forms a distributed constant circuit in cooperation with the conductor of the antenna 13 around the slit 14 and the substrate 11. For example, an inductance L exists in the antenna portion along the slit length and in the periphery of the antenna portion, and a capacitance C exists in the portion of the substrate 11 corresponding to the slit width and the periphery of the portion. The characteristic impedance of the distributed constant circuit is almost proportional to the square root of the inductance L, and is almost inversely proportional to the square root of the capacitance C.

The input impedance of the wireless IC chip 12 and the impedance of the antenna 13 are matched by adjusting the impedance of the antenna 13 by the following method.

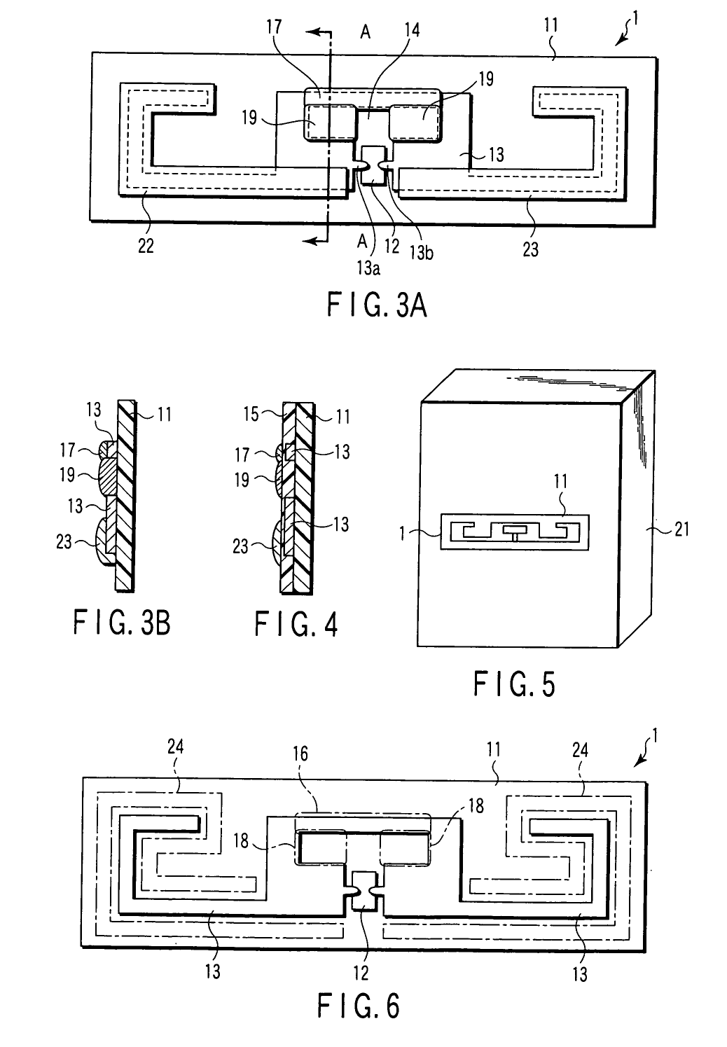

A magnetic material ejecting planned portion 16 is assumed in the antenna portion along the slit length and the periphery of the antenna portion as shown in FIG. 1A, a solution containing the magnetic material having required relative magnetic permeability, for example, relative magnetic permeability of 1.1 to 100 is ejected to the magnetic material ejecting planned portion 16 using an ink jet printer, and a magnetic pattern 17 is formed as shown in FIGS. 3A and 3B. By the magnetic pattern 17, the inductance L in the slit 14 increases, and the impedance of the antenna 13 increases. The magnetic material ejecting planned portion 16 is assumed on a control computer which will be described later and is not formed on the substrate 11.

A dielectric ejecting planned portion 18 is assumed as shown in FIG. 1A in the portion of the substrate 11 corresponding to the slit width and the periphery of the portion. A solution containing a dielectric material having required relative permittivity, for example, relative permittivity of 1.1 to 100 is ejected to the dielectric ejecting planned portion 18 using an ink jet printer, and a dielectric pattern 19 is formed as shown in FIGS. 3A and 3B. FIG. 3B is a cross section taken along line A-A of FIG. 3A. By the dielectric pattern 19, the capacitance C in the slit 14 increases, and the impedance of the antenna 13 decreases. The dielectric ejecting planned portion 18 is assumed on a control computer which will be described later and is not formed on the substrate 11.

The magnetic pattern 17 and the dielectric pattern 19 are formed not necessarily by single-layer coating but multilayer coating, and the thickness thereof can be adjusted. The magnetic material can be ejected to a part of the magnetic material ejecting planned portion 16, and the dielectric material can be ejected to a part of the dielectric ejecting planned portion 18, so that the area of each of the magnetic pattern 17 and the dielectric pattern 19 can be adjusted.

Since an ink jet printer is used, for example, the magnetic material or the dielectric material can be ejected in the unit of 1 to 5 pl at the minimum. Therefore, the thickness and area of the magnetic pattern 17 and the dielectric pattern 19 can be controlled on a fine unit basis, and the impedance of the antenna 13 can be adjusted with high accuracy. The method of forming the magnetic pattern 17 and the dielectric pattern 19 little by little while actually measuring the communication characteristic of the wireless tag 1 can be employed.

Further, the magnetic pattern 17 increases the impedance of the antenna 13, and the dielectric pattern 19 decreases the impedance of the antenna 13. Therefore, the impedance of the antenna 13 can be adjusted positively or negatively a plurality of times. In the case where the input impedance of the wireless IC chip 12 and the impedance of the antenna 13 are largely different from each other, a bidirectional adjustment approach can be taken such that the impedance is corrected by being increased or decreased and, when a correction value becomes excessive, the impedance is finely corrected in the opposite direction.

As the magnetic material ejected from the ink jet printer, a metal such as a magnetic material, iron, nickel, cobalt, or the like, or a compound or composite material of any of the elements typified by ferrite can be used. Particles of any of the materials, each having a diameter of 1 to 100 nm are dispersed in a solvent, and the resultant is used. As the dielectric material ejected from the ink jet printer, a high polymer material such as polyethylene, polyethylene terephthalate (PET), polypropylene, polyimide, epoxy, polypropylene, polycarbonate, polyoxymethylene, polymethyl methacrylate, or the like is dispersed in a solvent, and the resultant is used. Some of the high polymer materials can be used as a polymer or monomer without using a solvent. Further, as the dielectric material, glass, ceramics, or the like containing, as an element, barium, titanium, silicon, or the like can be also used. Particles of the dielectric material each having a diameter of 1 to 100 nm are dispersed in a solvent and the resultant is used.

A solvent selected from aliphatic hydrocarbons solvent, alicyclic hydrocarbons solvent, aromatic hydrocarbons solvent, petroleum naphtha solvent, halogen substitution of any of those solvents, and the like can be used. Examples are hexane, octane, isooctane, decane, isodecane, decaline, nonane, dodecan, and isododecane. Higher fatty acid ester and silicone oil can be also used.

As a solvent, for example, alcohols such as methyl alcohol, ethyl alcohol, propyl alcohol, butyl alcohol, and fluorinated alcohol, ketones such as acetone, methyl ethyl ketone, and cyclohexanone, carboxylate esters such as methyl acetate, ethyl acetate, propyl acetate, butyl acetate, methyl propionate, and ethyl propionate, ethers such as diethyl ether, dipropyl ether, tetrahydrofuran, and dioxane, halogenated hydrocarbons such as methylene dichloride, chloroform, carbon tetrachloride, dichloroethane, and methyl chloroform, and the like can be singularly or mixedly used.

To a solution ejected from the ink jet printer, various addition agents can be also added to assure stable ejecting like normal printing inks. The magnetic material and the dielectric material ejected from the ink jet printer are dried in short time at around 25° C. like normal printing inks. Consequently, the laser process, heating process, and process of soaking to a plating solution are not included, so that the object 21 to be recognized to which the wireless tag 1 is attached is not damaged. Therefore, in an actual use state in which the wireless tag 1 is attached to the object 21 to be recognized, the impedance of the antenna 13 can be finely adjusted, and accurate impedance matching can be carried out. In some cases, a drying process, an ultraviolet ray irradiation curing process, and the like at 50° C. or less at which the object 21 to be recognized is not damaged are included for the magnetic material and the dielectric material ejected onto the substrate 11.

As shown in FIG. 2, when the protection layer 15 is formed over the wireless IC chip 12 and the antenna 13, the magnetic material ejecting planned portion 16 and the dielectric ejecting planned portion 18 are assumed on the protection layer 15. For example, when the protection layer 15 is formed as a thin film made of a high polymer material or the like, the magnetic material and the dielectric material are ejected from the ink jet printer to the magnetic material ejecting planned portion 16 and the dielectric ejecting planned portion 18, respectively, thereby forming the magnetic pattern 17 and the dielectric pattern 19 on the protection layer 15 as shown in FIG. 4. In this case as well, the impedance of the antenna 13 can be finely adjusted in the actual use state in which the wireless tag 1 is attached to the object 21 to be recognized, and the accurate impedance matching can be performed.

Alternatively, irrespective of whether the protection layer 15 is formed or not, by ejecting a high polymer material or the like by the ink jet printer to necessary parts after formation of the magnetic pattern 17 and the dielectric pattern 19, the protection layer 15 can be formed. In this case, it is feared that the impedance of the antenna 13 varies due to the influence of the protection layer 15. Consequently, a method of gradually changing the thickness and the pattern of the protection layer 15 while measuring the communication characteristic of the wireless tag 1 in a manner similar to the case of forming the magnetic pattern 17 and the dielectric pattern 19 can be employed. As the material of the protection layer 15, a material whose relative permittivity and relative permeability is close to 1 is employed so that the influence on the impedance of the antenna 13 becomes small.

In the wireless tag 1, to perform transmission/reception effectively utilizing the maximum power in the resonance condition, an antenna adapted to a specific length such as half wavelength, ¼ wavelength, or the like using the wavelength of the used frequency as a reference is used. For example, an antenna 13 adapted to half wavelength is used in this case. When the wavelength of electromagnetic wave around the antenna 13 shifts in the case where the antenna 13 having a length adapted to the half wavelength of the used frequency is used, the antenna length and the half wavelength of the frequency of the high frequency current flowing in the antenna become deviated from each other. Therefore, the resonant condition cannot be obtained, transmission/reception effectively utilizing the maximum power cannot be performed and, as a result, the communication distance is shortened.

The deviation of the wavelength of the electromagnetic wave near the antenna 13 occurs when the propagation velocity of the electromagnetic wave around the antenna 13 changes due to the influence of the dielectric and the magnetic material around the wireless tag 1 and the wavelength shortening effect is produced. In the case where the influence of the dielectric and the magnetic material around the wireless tag cannot be ignored, the influence of the dielectric and the magnetic material of the object 21 to be recognized to which the wireless tag 1 is adhered is the largest.

Even when the object 21 to be recognized is a product manufactured by mass production in which the specifications are determined, it is difficult to manage variations in the permittivity and permeability. In particular, it is extremely difficult to manage the permittivity and permeability at the time of production of daily-use articles, food, clothing or the like except for special cases. The permittivity and permeability of a mail and a small packet also vary among objects of adhesion due to variations in the contents and packages.

In the case where the permittivity and permeability of the object 21 to be recognized are unpredictable as described above, it is difficult to manufacture the wireless tag 1 in advance so that the antenna length matches the half wavelength of the frequency of high frequency current flowing in the antenna for any objects 21 to be recognized. Variations in the permittivity and permeability of the periphery of the wireless tag 1 are influenced not only by the physical property values of the object 21 to be recognized but also by variations in the shape of the object to be recognized and, further, deformation and distortion of the wireless tag 1 at the time of adhesion, variations in the material of the substrate 11, and the like.

In the embodiment, therefore, by employing a method of making the half wavelength of the frequency of high frequency current flowing in the antenna in the wireless tag 1 and the antenna length match each other in an actual use state in which the wireless tag 1 is adhered to the object 21 to be recognized, a reliable resonant condition is obtained.

The method of making the half wavelength of the frequency of the high frequency current flowing in the antenna 13 match with the antenna length in an actual use state in which the wireless tag 1 is adhered to the object 21 to be recognized will be described below.

As shown in FIG. 1A, a wavelength shortening material ejecting planned portion 22 is assumed on the antenna 13 and its periphery. A wavelength shortening material which is a dielectric material having required relative permittivity or a magnetic material having required relative permeability is ejected to the wavelength shortening material ejecting planned portion 22 by using an ink jet printer, thereby forming a wavelength shortening layer pattern 23 on the antenna 13 and its periphery as shown in FIGS. 3A and 3B. The wavelength shortening material ejecting planned portion 22 is assumed on a control computer which will be described later and is not formed on the substrate 11.

The propagation speed of the electromagnetic wave around the antenna in the wireless tag 1 is almost inversely proportional to the relative permittivity and relative permeability. Therefore, when the wavelength shortening pattern 23 made of the dielectric material having required relative permittivity or the magnetic material having required relative permeability is formed on and around the antenna 13, the propagation speed of the electromagnetic wave around the antenna in the wireless tag 1 decreases. Consequently, the wavelength of the high frequency current flowing in the antenna 13 becomes shorter than that of predetermined frequency used in the wireless tag 1.

Matching between the half wavelength of the frequency of the high frequency current flowing in the antenna 13 and the antenna length can be realized by shortening the wavelength of the high frequency current flowing in the antenna 13 by adjusting the relative permittivity or relative permeability of the wavelength shortening layer pattern 23.

The value of the maximum permittivity or maximum permeability of the expected object 21 to be recognized is used as a reference, and the half wavelength of the frequency of the high frequency current flowing in the antenna 13 is set as the initial value of the antenna length. The wireless tag 1 based on the initial value is generated and adhered to the object 21 to be recognized, or the wireless tag 1 is directly formed on the surface of the object 21 to be recognized. That is, the antenna 13 having the expected minimum length is initially formed.

A solution containing a dielectric material having required relative permittivity, for example, a relative permittivity of 1.1 to 100 or a solution containing a magnetic material having, required relative permittivity, for example, a relative permeability of 1.1 to 100 is ejected to the wavelength shortening material ejecting planned portion 22 disposed on and around the antenna portion from an ink jet printer, thereby forming the wavelength shortening layer pattern 23 as shown in FIGS. 3A and 3B. In such a manner, the wavelength of the high frequency current flowing in the antenna 13 is shortened. The wavelength shortening material ejected is not limited to the dielectric material or the magnetic material but may be a mixture of the dielectric material and the magnetic material.

The thickness of the wavelength shortening layer pattern 23 is limited from the viewpoint of easy peeling property and usability of the object 21 to be recognized itself in an actual use state in which the wireless tag 1 is adhered to the object 21 to be recognized. The thickness is preferably, for example, about 0.1 to 1 mm. Therefore, the method is preferable to the case where variations in the permittivity or permeability of the object 21 to be recognized are relatively small.

In a manner similar to formation of the magnetic pattern 17 and the dielectric pattern 19 in adjustment of the slit 14, the wavelength shortening layer pattern 23 can be formed not necessarily by single-layer coating but by multilayer coating, and the thickness thereof can be adjusted. The area of the wavelength shortening layer pattern 23 can be also adjusted. Therefore, by finely adjusting the relative permittivity or relative permeability of the wavelength shortening layer pattern 23, the wavelength of the high frequency current flowing in the antenna 13 can be shortened and adjusted with high precision. Consequently, the method of forming the wavelength shortening layer pattern 23 little by little while actually measuring the communication characteristic of the wireless tag 1 can be employed.

Since the dielectric material or the magnetic material of the wavelength shortening layer pattern 23 is used just to shorten the wavelength of the high frequency current flowing in the antenna 13, it is necessary to pay attention not to cause overshooting due to excessive shortening. In the case where the communication characteristic is becoming close to the resonant condition indicative of match between the half wavelength of the frequency of the high frequency current flowing in the antenna and the antenna length, a fine adjustment amount is required.

As the wavelength shortening material, the dielectric material or magnetic material similar to that in the case of forming the magnetic pattern 17 and the dielectric pattern 19 in adjustment of the slit 14 can be used. To the solution ejected from the ink jet printer, similarly, any of various addition agents is added to assure stable ejecting, and the resultant solution can be used like a normal printing ink.

Since the wavelength shortening material is formed in a manner similar to the case of forming the magnetic pattern 17 and the dielectric pattern 19 in adjustment of the slit 14, the magnetic material and the dielectric material ejected from the ink jet printer are dried in short time at around 25° C. like a printing ink ejected from the ink jet printer. Consequently, the object 21 to be recognized to which the wireless tag 1 is attached is not damaged. Therefore, in an actual use state in which the wireless tag 1 is attached to the object 21 to be recognized, the wavelength of the high frequency current flowing in the antenna 13 can be finely adjusted, and accurate matching with the antenna length and excellent resonance condition can be obtained. In some cases, a drying process, an ultraviolet ray irradiation curing process, and the like at 50° C. or less at which the object 21 to be recognized is not damaged are included for the magnetic material and the dielectric material ejected onto the substrate 11.

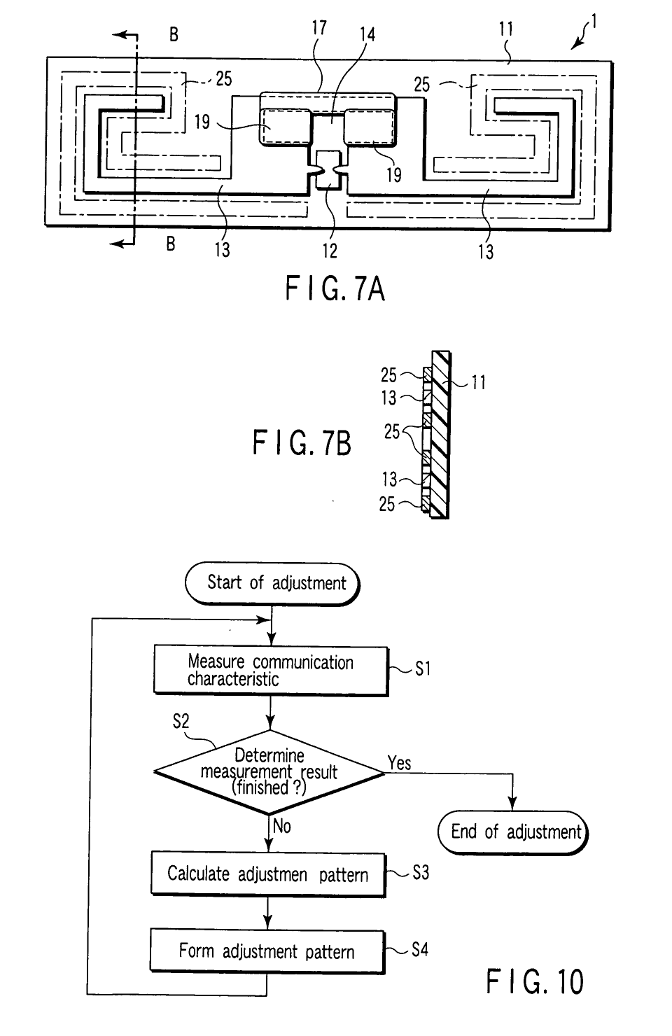

When the wavelength shortening layer pattern 23 having high permittivity or high permeability exists in the direction of arrival of electric waves, a dielectric loss and a magnetic loss is large, and a large loss occurs in the energy of electromagnetic wave emitted. Therefore, in the case where the wavelength shortening layer pattern 23 becomes thick, as shown in FIG. 6, it is sufficient to assume the wavelength shortening material ejecting planned portion 24 on and around the antenna 13 and form the wavelength shortening layer pattern 25 in the wavelength shortening material ejecting planned portion 24 as shown in FIGS. 7A and 7B. FIG. 7B is a cross section taken along line B-B of FIG. 7A. The wavelength shortening layer pattern 25 can be also formed on the surface of the object 21 to be recognized on the outside of the substrate 11 as long as the object 21 to be recognized is not damaged. The wavelength shortening material ejecting planned portion 24 is assumed on a control computer which will be described later and is not formed on the substrate 11.

Next, a wireless tag adjusting system for obtaining a match between the impedance of the antenna 13 and the input impedance of the wireless IC chip 12 and a match between the half wavelength of the frequency of the high frequency current flowing in the antenna 13 and the length of the antenna 13 in the actual use state in which the wireless tag 1 is adhered to the object 21 to be recognized will be described.

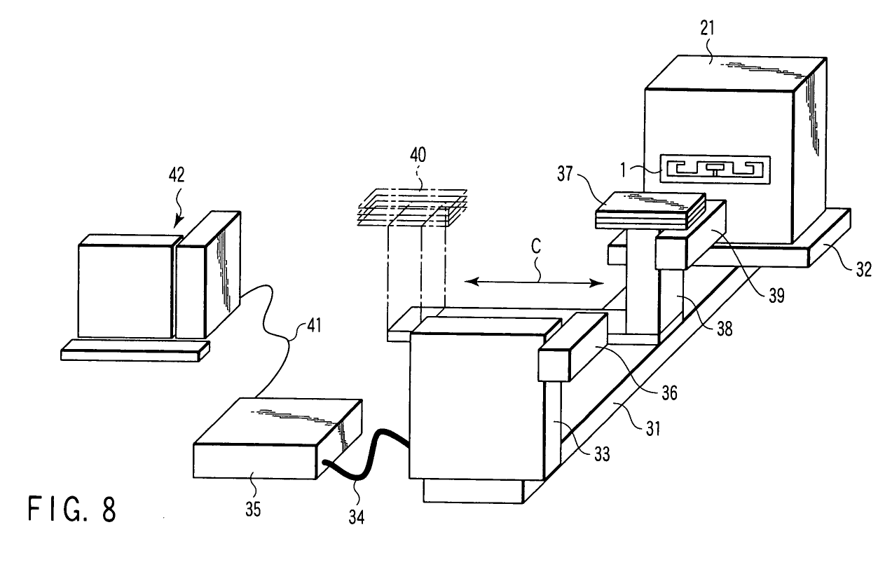

As shown in FIG. 8, a holding table 32 that holds the object 21 to be recognized to which the wireless tag 1 is attached is mounted at one end of a movable table 31. A reader antenna 33 for a wireless tag is connected to an interrogator 35 via a coaxial cable 34. The reader antenna 33 is mounted on the movable table 31 and can move, obviously, up and down, left and right, and front and rear directions and can also perform tri-axis rotation and the like. An antenna positioning camera 36 is mounted on the reader antenna 33, so that the relative positions between the reader antenna 33 and the wireless tag 1 can be measured accurately.

An ink jet printer 37 is disposed between the holding table 32 and the reader antenna 33. The ink jet printer 37 is mounted on a movable table 38 for ink jet and can move up and down, right and left, and front and rear directions. A head positioning camera 39 is mounted on the ink jet printer 37, so that relative positions between the ink jet head included in the ink jet printer 37 and the wireless tag 1 can be measured. With the configuration, a necessary ejecting material can be ejected to a predetermined ejecting planned portion in the wireless tag 1. The movable table 38 for ink jet is mounted on the movable table 31.

The ink jet printer 37 can move in the horizontal directions as shown by the arrow C in the diagram by the movable table 38 for ink jet. At the time of measuring the communication characteristic of the wireless tag 1 by the reader antenna 33, the ink jet printer 37 withdraws to an apparatus withdrawal position 40 so as not to exert an influence on propagation of electromagnetic waves. The ink jet printer 37 is constructed by the ink jet head, an ink supplying device, a ejecting driving circuit, and the like. The ink head is made by a conductor ejecting head, a dielectric ejecting head, and a magnetic material ejecting head which ejecting a solution ink containing a conductor material, a solution ink containing a dielectric material, and a solution ink containing a magnetic material, respectively.

A control computer 42 is connected to the interrogator 35 via a communication cable 41. The control computer 42 is connected to components of the system via an interface to collect the communication characteristics of the wireless tag 1, calculate an antenna adjustment pattern using the communication characteristics, and actually form the calculated antenna adjustment pattern in the ink jet printer 37. The control computer 42 controls the overall wireless tag adjusting system.

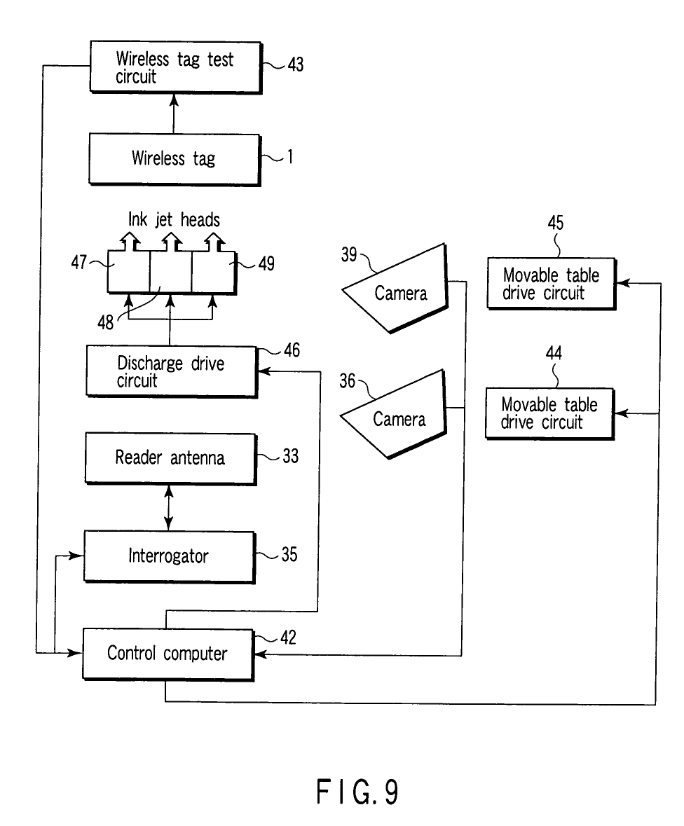

FIG. 9 is a block diagram showing a control configuration of the wireless tag adjusting system, and the interrogator 35, the reader antenna 33, and the wireless tag 1 form an RFID system. The interrogator 35 transmits an electric wave signal to the wireless tag 1 via the reader antenna 33. The wireless tag 1 receives the transmitted electric wave from the reader antenna 33, gives reflection modulation to an input signal on the basis of information stored in an internal memory, and transmits the resultant signal to the reader antenna 33. When the reader antenna 33 receives the signal sent back from the wireless tag 1, the interrogator 35 modulates the signal and extracts tag information. In such an RFID system, for example, frequency bands such as 13.56 MHz band, 900 MHz band, and 2.45 GHz band are used.

The control computer 42 is connected to the interrogator 35 via the interface and collects information such as the gain and frequency as reception characteristics of electric waves sent back from the wireless tag 1. The control computer 42 also controls transmission of an electric wave signal from the interrogator 35. The control computer 42 can directly collect information such as the gain and frequency as reception characteristics of the wireless tag 1 via a wireless tag test circuit 43 which can be electrically connected to the wireless tag 1. Further, the control computer 42 is connected to a reader antenna moving system made by a drive circuit 44 of the movable table 31 and the antenna positioning camera 36 and controls, for example, measurement of the spatial communication characteristics such as the maximum communicatable distance.

The control computer 42 calculates an adjustment pattern of the antenna 13 from information such as the reception characteristic of the electric wave from the interrogator 35 and the reception characteristic in the wireless tag 1. For example, the control computer 42 calculates data of the area and thickness as shape information of the magnetic pattern 17 and the dielectric pattern 19 for matching between the impedance of the antenna 13 and the input impedance of the wireless IC chip 12. Similarly, the control computer 42 calculates data of the area and thickness as shape information of the wavelength shortening layer pattern 23 (or 25) made of the magnetic material or dielectric for making the half wavelength of the frequency of the high frequency current flowing in the antenna 13 and the length of the antenna 13 match each other.

For calculation of the adjustment pattern, an electromagnetic simulation in the total space including a ejected material from the ink jet printer 37, the antenna 13 formed initially, the substrate 11 of the wireless tag 1, and the object 21 to be recognized to which the wireless tag 1 is adhered can be used. As a method of simulation, for example, the method disclosed in Toru Uno, “FDTD method for Electromagnetics and antennas”, Corona Publishing Co., Ltd., 1998 can be used.

The formation information is transmitted as ejecting position information and ejecting amounts of the conductor, magnetic material, and dielectric to a drive circuit 45 of the movable table 38 for ink jet and a ejecting drive circuit 46 of the ink jet printer 37. The ejecting drive circuit 46 of the ink jet printer 37 controls the driving of a conductor ejecting head 47, a dielectric ejecting head 48, and a magnetic material ejecting head 49.

The control computer 42 is connected to the drive circuit 45 of the movable table 38 for ink jet, the ink jet head moving system made by the head positioning camera 39, and the ejecting drive circuit 46 of the ink jet printer 37, and three-dimensionally controls formation of the antenna adjustment pattern.

Next, an antenna adjustment basic algorithm of the wireless tag 1 will be described, which uses the wireless tag adjusting system shown in FIGS. 8 and 9, obtains matching between the impedance of the antenna 13 and the input impedance of the wireless IC chip 12 in the actual use state in which the wireless tag 1 is attached to the object 21 to be recognized, and makes the half wavelength of the frequency of the high frequency current flowing in the antenna 13 and the length of the antenna 13 coincide with each other. The antenna adjustment basic algorithm is executed by the control computer 42.

The antenna adjustment basic algorithm is formed by, as shown in FIG. 10, a communication characteristic measuring step S1, a measurement result determining step S2, an adjustment pattern calculating step S3, and an adjustment pattern forming step S4.

First, after start of adjustment, the communication characteristics of the wireless tag 1 are measured in the communication characteristic measuring step S1 on the initial antenna pattern 13. As the communication characteristics, for example, the gain, the frequency, the communicatable distance, and the like as reception characteristics of electric waves sent from the wireless tag 1 are output as measurement results.

Next, the measurement results are determined in the measurement result determining step S2. When the initial antenna pattern 13 assures sufficient communication characteristics, the adjustment is finished. For example, in the case where the gain, frequency, and communicatable distance as electric wave reception characteristics of measurement have values close to the maximum gain, planned frequency, and maximum communicatable distance of the reception characteristics of expected electric waves, the adjustment is finished.

In an adjusting method in which the state of the antenna impedance and the antenna length cannot be reversed, for example, if an overshoot state in which the communicatable distance becomes different from the maximum communicatable distance occurs, the adjustment is finished. Also in the case where there is no room for antenna adjustment and the gain, frequency, and communicatable distance as the reception characteristics of the measurement electric waves are the same as those of the measurement result determination of last time, the adjustment is finished. The state where there is no room for antenna adjustment is, for example, a state where the required amount of the ejected solution for adjustment is equal to or less than the minimum droplet volume which can be formed by the ink jet printer 37.

In the case where the communication characteristics are insufficient, subsequently, in the adjustment pattern calculating step S3, an adjustment pattern calculating process is performed. Specifically, the wireless tag antenna adjustment pattern made of shape information of the conductor pattern, the magnetic pattern 17, the dielectric pattern 19, and the wavelength shortening layer pattern 23 (or 25) based on the communication characteristics and the like of the electric waves in the control computer 42 is calculated. The wireless tag antenna adjustment pattern is calculated for each ejected material. Since the calculation includes an error, the wireless tag antenna adjustment pattern is converted to a fine adjustment pattern by, for example, fine adjustment in which the adjustment amount is divided into five to ten times. Therefore, after that, an error correcting approach of measuring the communication characteristics for each adjustment and re-calculating an adjustment pattern is executed.

Subsequently, in the adjustment pattern forming step S4, conductor discharge, dielectric discharge, and magnetic material ejecting are performed on the basis of the ejecting material information on the calculated fine adjustment pattern for each of the ejecting materials. In the adjustment pattern forming step of once, one ejecting material is ejected, or a plurality of ejecting materials are ejected.

The control method is the same as that in the case of performing full-color printing using four ink jet heads corresponding to yellow, magenta, cyan, and black in the ink jet printer 37, and a three-dimensional pattern made by an arbitrary combination of the conductor, dielectric, and magnetic material can be formed by the operation of the movable table 38 for ink jet. For example, in the case of simultaneously adjusting wavelength matching and impedance matching, the magnetic pattern 17 and the dielectric pattern 19 are simultaneously formed. In the case of generating the wavelength shortening layer pattern 23 (or 25), the magnetic material and the dielectric material are ejected in the adjustment pattern forming step of once, and a complex of the magnetic material and the dielectric material can be also formed on the wireless tag 1.

Subsequently, the control computer 42 returns to the communication characteristic measuring step of S1, and repeats the error correcting approach of adjusting the antenna little by little.

The antenna adjustment algorithm is not limited to the above-described algorithm but a method which differs according to a wireless tag and an object may be employed.

Next, some examples of the error correcting approach will be described.

With respect to the impedance matching, the impedance of the antenna 13 and the input impedance of the wireless IC chip 12 are matched. With respect to antenna resonance adjustment, the half wavelength of the frequency of the high frequency current flowing in the antenna 13 and the length of the antenna 13 are made to coincide with each other. The two adjustment items have to be finally satisfied.

As an example of the approaching method satisfying the two adjustment items, an item-by-item adjusting approach will be described. The method is a method of maximally repeatedly performing one of “antenna resonance adjustment” and “impedance matching adjustment”, after that, maximally repeatedly performing the other adjustment, and alternately performing the “antenna resonance adjustment” and the “impedance matching adjustment” again.

FIG. 11 is a flowchart showing internal processes in the adjustment pattern calculating step S3 in FIG. 10 which is constructed by an algorithm of an item-by-item adjustment approach of performing “antenna resonance adjustment” first and then “impedance matching adjustment”.

When the algorithm moves from the measurement result determining step S2 to the adjustment pattern calculating step S3, first, in S11, adjustment mode selecting process is executed. Which adjusting mode of “antenna resonance adjustment mode” or “impedance matching adjustment mode” is selected is determined by an adjustment mode flag Flg1. In the case of Flg1=A, “antenna resonance adjustment mode” is selected. In the case of Flg1=Z, “impedance matching adjustment mode” is selected. The initial condition is set as Flg1=A, and the “antenna resonance adjustment mode” is processed first.

After the “antenna resonance adjustment mode” is selected, in S12, an antenna resonance adjustment saturation determining process is executed. For example, in the case where the gain, frequency, and communicatable distance as reception characteristics of electric waves of measurement are close to the maximum gain, predetermined frequency, and maximum communicatable distance of expected reception characteristics of electric waves, or in the case where there is no room for antenna adjustment and the gain, frequency, and communicatable distance as the reception characteristics of electric waves as a measurement result are the same as those of antenna resonance adjustment saturation determination of last time, it is determined that the adjustment is saturated.

When it is determined that the adjustment is saturated, in S13, an adjustment mode flag switching process is executed. When it is determined that the adjustment is not saturated yet, in S14, an antenna resonance adjustment pattern calculating process is executed. In the adjustment mode flag switching process (S13), the adjustment mode flag Flg1 is changed from the “antenna resonance adjustment mode” =A to the “impedance matching adjustment mode” =Z. That is, Flg1=Z is set. In S15, an impedance matching adjustment pattern calculating process is executed. If the impedance matching adjustment is already saturated, the end is determined in the measurement result determining step S2 in the antenna adjustment basic algorithm in FIG. 10, so that the routine does not reach this step.

In the antenna resonance adjustment pattern calculating process (S14), the antenna resonance adjustment pattern made of the shape information of the conductor pattern and the wavelength shortening layer pattern 23 (or 25) is calculated on the basis of the communication characteristic and the like. The adjustment pattern is calculated for each ejecting material. After that, the routine moves to the adjustment pattern forming step S4 in the antenna adjustment basic algorithm of FIG. 10.

In the case where “impedance matching adjustment mode” is selected, in S16, an impedance matching adjustment saturation determining process is executed. For example, in the case where the gain, frequency, and communicatable distance as reception characteristics of electric waves of measurement are close to the maximum gain, predetermined frequency, and maximum communicatable distance of expected reception characteristics of electric waves, or in the case where there is no room for antenna adjustment and the gain, frequency, and communicatable distance as the reception characteristics of electric waves as a measurement result are the same as those of impedance matching adjustment saturation determination of last time, it is determined that the adjustment is saturated.

In the case where it is determined that the adjustment is saturated, in S17, an adjustment mode flag switching process is executed. When it is determined that the adjustment is not saturated yet, in S15, an impedance matching adjustment pattern calculating process is executed. In the adjustment mode flag switching process (S17), the adjustment mode flag Flg1 is changed from the “impedance matching adjustment mode”=Z to the “antenna resonance adjustment mode”=A. That is, Flg1=A is set. In S14, an antenna resonance adjustment pattern calculating process is executed. If the antenna resonance adjustment is also already saturated, the end is determined in the measurement result determining step S2 in the antenna adjustment basic algorithm in FIG. 10, so that the routine does not reach this step.

In the impedance matching adjustment pattern calculating process (S15), the impedance matching adjustment pattern made of the shape information of the conductor pattern, the magnetic pattern 17, the dielectric pattern 19, and the like is calculated on the basis of the communication characteristic and the like. The adjustment pattern is calculated for each ejecting material. After that, the routine moves to the adjustment pattern forming step S4 in the antenna adjustment basic algorithm of FIG. 10.

The algorithm of the adjustment approach is not limited to the above algorithm, and a method which differs according to a wireless tag and an object may be employed.

When the fine adjustment pattern is small, the adjustment precision improves but adjustment time is long. Consequently, in the impedance matching adjustment, by using the fact that the magnetic pattern 17 increases the impedance of the antenna 13 and the dielectric pattern 19 decreases the impedance of the antenna 13, a bidirectional adjustment approach capable of shortening the adjustment time can be executed.

The case of applying the bidirectional adjustment approach to the impedance matching adjustment will be described hereinbelow.

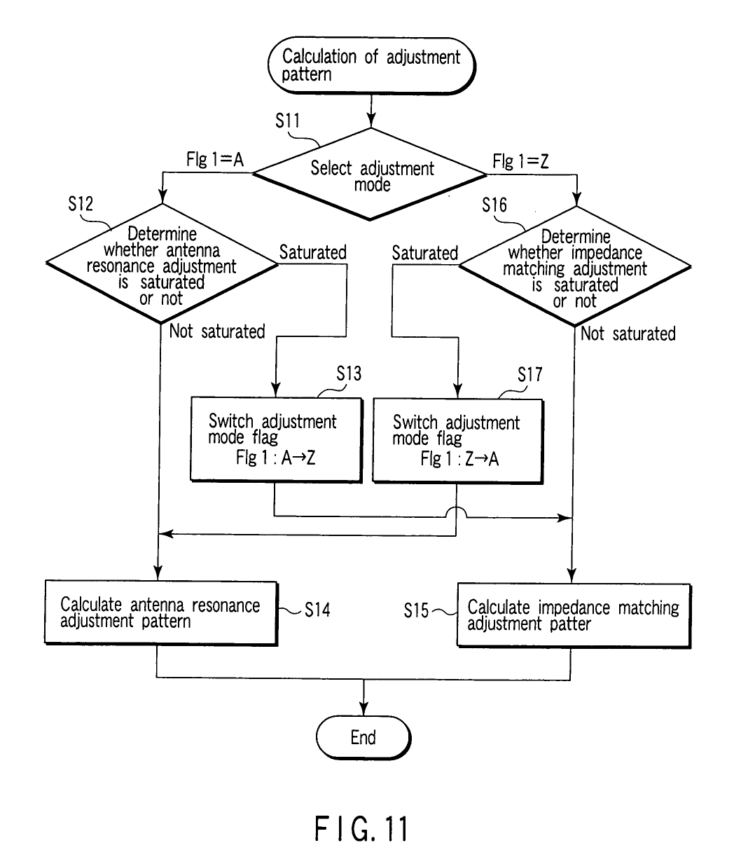

FIG. 12 is a flowchart showing internal processes in the impedance matching adjustment pattern calculating process (S15) in FIG. 11, which is constructed by an algorithm of the bidirectional adjustment approach.

When the algorithm moves to the impedance matching adjustment pattern calculating process (S15), first, in S21, impedance adjustment direction selecting process is executed. Which adjusting direction of “impedance decreasing direction adjustment” or “impedance increasing direction adjustment” is selected is determined by an adjustment direction flag Flg2.

In the case of Flg2=N, “impedance decreasing direction adjustment” is selected. For example, calculation and formation of the dielectric pattern 19 is selected as a process. In the case of Flg2=P, “impedance increasing direction adjustment” is selected. For example, calculation and formation of the magnetic pattern 17 is selected as a process. The initial condition is set as Flg2=N, and the “impedance decreasing direction adjustment” is processed first.

The initial condition is, for example, a condition such that in the pattern of the initial slit 14, the impedance of the antenna 13 is sufficiently large with respect to the input impedance of the wireless IC chip 12, and “impedance decreasing direction adjustment” that is, calculation and formation of the dielectric pattern 19 is initially set.

When “impedance decreasing direction adjustment” is selected by Flg2=N, in S22, an impedance matching improvement determining process is executed.

The impedance matching improvement determination is made by, for example, comparing the gain, frequency, and communicatable distance as reception characteristics of electric waves as a measurement result in the communication characteristic measurement step S1 in FIG. 10 with the values used for the impedance matching improvement determination of last time. In the case where it is determined that the matching of impedance has improved from that of last time (for example, the gain became larger, the communicatable distance became longer, or the like), in S23, an impedance decreasing direction adjustment pattern calculating process is executed. In the case where it is determined that the matching of impedance deteriorates as compared with that of last time (for example, the gain became smaller, the communicatable distance became shorter, or the like), in S24, an adjustment direction flag switching process is executed.

In the case where impedance matching is the same as that of last time, the adjustment mode flag is switched in the impedance matching adjustment saturation determining process (S16) in FIG. 11, so that this process is not executed. The impedance matching of the initial value is set to the lowest level.

In the adjustment direction flag switching process (S24), it is determined that impedance matching has passed the best point (peak), and the adjustment mode flag Flg2 is changed from “impedance decreasing direction adjustment” (N) to “impedance increasing direction adjustment” (P). That is, Flg2 is set to P. For example, a ejecting amount per time of conductor, dielectric, and magnetic material, that is, an adjustment amount Adj per time is decreased. For example, an adjustment amount Adj(n) used for adjustment of this time is set to ½ of an adjustment amount Adj(n−1) of last time. That is, Adj(n)=Adj(n−1)/2. The routine shifts to an impedance increasing direction adjustment pattern calculating process in S25.

In the impedance decreasing direction adjustment pattern calculating process in S23, the impedance decreasing direction adjustment pattern made of the shape information of the conductor pattern, the magnetic pattern 17, the dielectric pattern 19, or the like is calculated on the basis of the communication characteristic and the like. The adjustment pattern is calculated for each ejecting material.

For example, an adjustment pattern is calculated so as to form the dielectric pattern 19 only by a specific adjustment amount Adj(n) in the dielectric ejecting planned portion 18. The adjustment pattern makes the impedance of the antenna 13 decrease.

After calculation of the adjustment pattern, the impedance matching adjustment pattern calculating process (S15) in FIG. 11 is finished, and the routine shifts to the adjustment pattern forming step S4 in FIG. 10.

In the case where “impedance increasing direction adjustment” is selected (Flg2=P), in S26, an impedance matching improvement determining process is executed.

For example, the gain, frequency, and communicatable distance as reception characteristics of electric waves as a measurement result in the communication characteristic measuring step S1 in FIG. 10 are compared with the values used in the impedance matching improvement determination of last time. In the case where it is determined that the matching of impedance has improved from that of last time (for example, the gain became larger, the communicatable distance became longer, or the like), in S25, an impedance increasing direction adjustment pattern calculating process is executed. In the case where it is determined that the matching of impedance deteriorates as compared with that of last time (for example, the gain became smaller, the communicatable distance became shorter, or the like), in S27, an adjustment direction flag switching process is executed.

In the case where impedance matching is the same as that of last time, the adjustment mode flag is switched in the impedance matching adjustment saturation determining process (S16) in FIG. 11, so that this process is not executed.

In the adjustment direction flag switching process in S27, it is determined that impedance matching has passed the best point (peak), and the adjustment mode flag Flg2 is changed from “impedance increasing direction adjustment” (P) to “impedance direction decreasing adjustment” (N). That is, Flg2 is set to N. For example, a ejecting amount per time of conductor, dielectric, and magnetic material, that is, an adjustment amount Adj per time is decreased. For example, an adjustment amount Adj(n) used for adjustment of this time is set to ½ of an adjustment amount Adj(n−1) of last time. That is, Adj(n)=Adj(n−1)/2. The routine shifts to an impedance decreasing direction adjustment pattern calculating process in S23.

In the impedance increasing direction adjustment pattern calculating process in S25, the impedance increasing direction adjustment pattern made of the shape information of the conductor pattern, the magnetic pattern 17, the dielectric pattern 19, or the like is calculated on the basis of the communication characteristic and the like. The adjustment pattern is calculated for each ejecting material.

For example, an adjustment pattern is calculated so as to form the magnetic pattern 17 only by a specific adjustment amount Adj(n) in the magnetic material ejecting planned portion 16. The adjustment pattern makes the impedance of the antenna 13 increase.

After calculation of the adjustment pattern, the impedance matching adjustment pattern calculating process (S15) in FIG. 11 is finished, and the routine shifts to the adjustment pattern forming step S4 in FIG. 10.

By using the method of FIG. 12, the adjustment can be performed with a large adjustment amount from the beginning. As compared with the case of a process using a small adjustment amount from the beginning, antenna adjustment can be finished in shorter time.

Although the case of applying the bidirectional adjustment approach to the impedance matching adjustment has been described above, if the adjusting method has the adjusting function in both directions, the bidirectional adjustment approach can be applied to the other adjustment items.

Next, the case of performing antenna resonance adjustment only by a method of shortening the wavelength of the high frequency current flowing in the antenna will be described. In this case, the adjusting direction is only one direction of the shortening direction, so that attention has to be paid to overshooting caused by excessive shortening. Once overshooting occurs, the wavelength cannot be reversed to the original state.

In the antenna resonance adjustment, when the communication characteristic is becoming close to the resonant condition indicative of matching of the half wavelength of the frequency of the high frequency current flowing in the antenna and the antenna length, the adjustment amount has to be decreased.

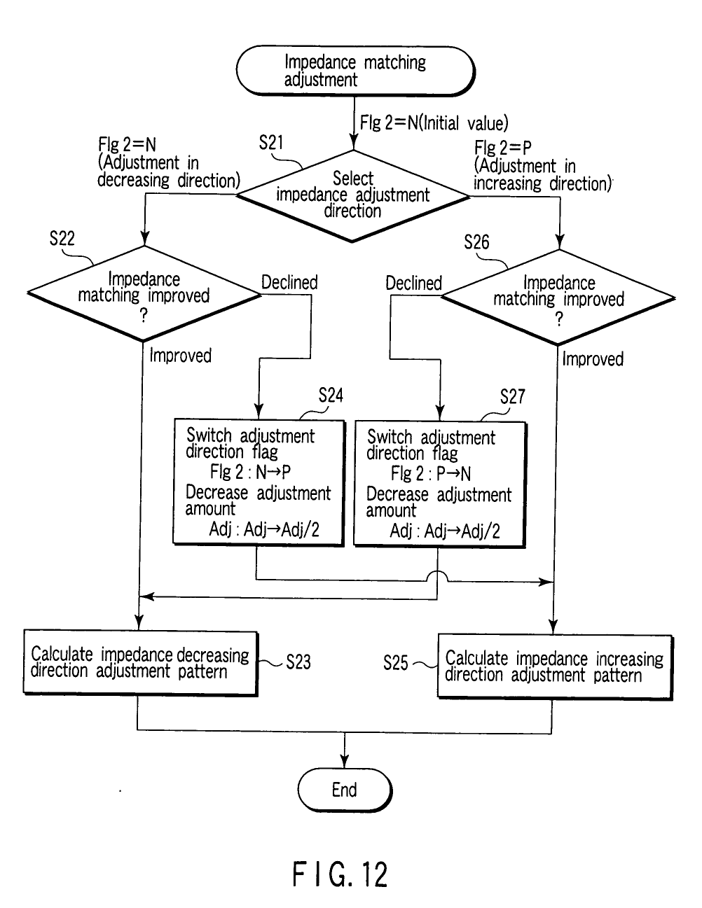

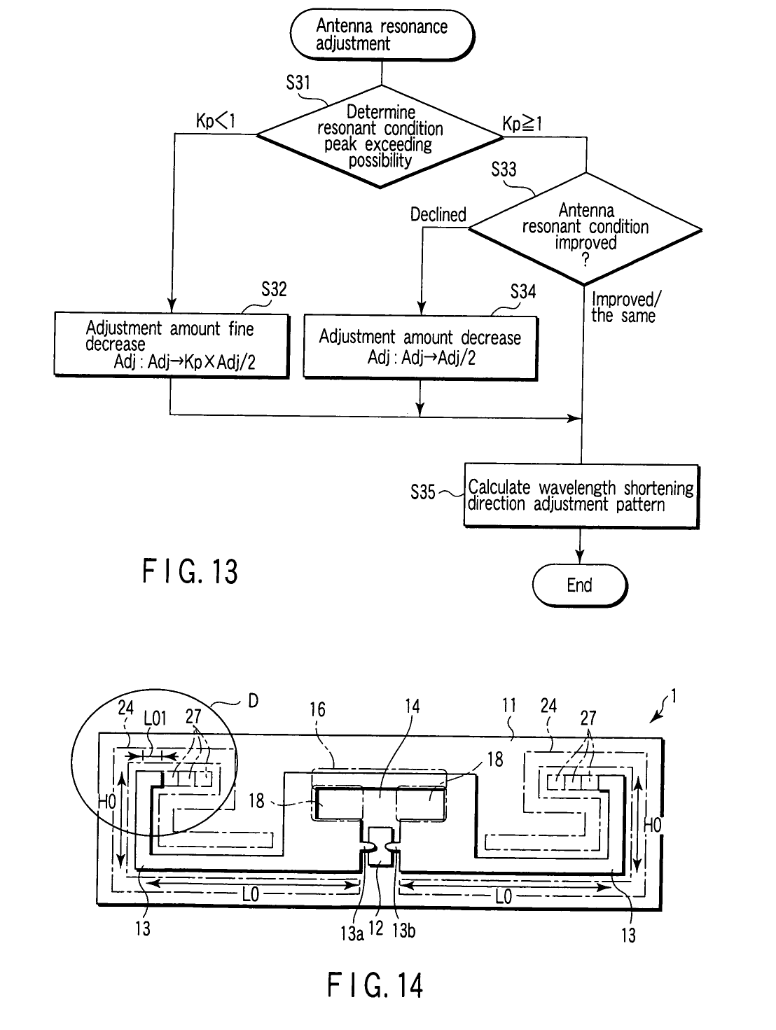

FIG. 13 is a flowchart showing internal processes in the antenna resonance adjustment pattern calculating process (S14) in FIG. 11, which is constructed by an algorithm of the one-directional adjustment approach. As the communication characteristic, the communicatable distance is employed for explanation, but a composite value with another value may be also used. As the initial setting, the antenna 13 having the assumed minimum length is initially formed in the object 21 to be recognized.

In the antenna resonance adjustment pattern calculating process S14, first, in S31, a resonant condition peak exceeding possibility determining process is executed. In the process, the possibility that the adjustment exceeds the peak of the resonant condition by the adjustment amount of this time is determined. For example, an increase amount of the communicatable distance in the adjustment amount of last time is set as ΔLng, the maximum communicatable distance is set as LngMax, the communicatable distance at present is set as Lng, and the possibility Kp that the adjustment exceeds the peak of the resonant condition by the adjustment amount of this time is set as Kp=(LngMax−Lng)/ΔLng.

In the case of Kp<1, it is determined that the possibility that the adjustment exceeds the peak of the resonant condition by the adjustment amount of this time is high, and the routine shifts to an adjustment amount finely decreasing process in S32.

In the case of Kp≧1, it is determined that the possibility that the adjustment exceeds the peak of the resonant condition by the adjustment amount of this time is low, and the routine shifts to an antenna resonant condition improvement determining process of S33.

In the adjustment amount finely decreasing process in S32, it is determined from the communicatable distance that the current length of the antenna is close to a state where the peak of the resonant condition is obtained. In this case, for example, the adjustment amount Adj per time as the ejecting amount per time of the conductor, dielectric, or magnetic material is decreased from the value of last time.

For example, the adjustment amount Adj(n) used for adjustment of this time is set to Kp/2 of the adjustment amount Adj(n−1) of last time. That is, Adj(n)=KpxAdj(n−1)/2. Since the adjustment amount Adj(n−1) is multiplied by a value Kp which is less than 1, the adjustment amount is smaller than an adjustment amount obtained by simply multiplying the adjustment amount Adj(n−1) by ½, and the risk that the adjustment exceeds the resonant condition can be avoided.

In the antenna resonant condition improvement determining process in S33, it is determined from the communicatable distance that the present length of the antenna is far from the state where the peak of the resonant condition is obtained. In this case, by comparing the measurement result of last time and that of this time with each other, whether the antenna resonant condition has improved or not is determined.

For example, the communicatable distance or the like as a measurement result in the communication characteristic measuring step S1 in FIG. 10 is compared with the value of last time. For example, when the increase amount of the communicatable distance is smaller than that of the last time, it is determined that the degree of improvement in the antenna resonant condition is lower than that of last time, and the routine shifts to the adjustment amount decreasing process in S34. In the case where the increase amount of the communicatable distance is either larger than or equal to that of last time, it is determined that the degree of improvement in the antenna resonant condition is higher than or equal to that of last time, and the routine shifts to the wavelength shortening direction adjustment pattern calculating process of S35. In determination of the improvement in the antenna resonant condition for the first time, an initial setting is made so that the degree of improvement in the antenna resonant condition is the same as that of last time.

In the adjustment amount decreasing process in S34, it is determined from the communicatable distance that the present length of the antenna is far from the state where the peak of the resonant condition is obtained. However, since the degree of improvement in the antenna resonant condition is lower than that of last time, the length of the antenna is approaching the state where the peak of the resonant condition is obtained. The adjustment amount Adj per time as the ejecting amount per time of the conductor, dielectric, or magnetic material is decreased to be smaller than that of last time. For example, the adjustment amount Adj(n) used for the adjustment of this time is set to ½ of the adjustment amount Adj(n−1) of last time. That is, Adj(n)=Adj(n−1)/2.

In the wavelength shortening direction adjustment pattern calculating process in S35, the wavelength shortening direction adjustment pattern made by the shape information of the conductor pattern, the magnetic pattern 17, the dielectric pattern 19 or the like is calculated on the basis of the communication characteristic or the like. The adjustment pattern is calculated for each of the ejecting materials. For example, an adjustment pattern is calculated so as to form the wavelength shortening layer pattern 23 (or 25) only by a specified adjustment amount Adj(n) by ejecting the wavelength shortening material made by the dielectric material having required relative permittivity or the magnetic material having required relative permeability from the ink jet printer 37 to the wavelength shortening material ejecting planned portion 22 (or 24).

After calculation of the adjustment pattern, the antenna resonance adjustment pattern calculating process (S14) in FIG. 11 is finished, and the routine shifts to the adjustment pattern forming step S4 in FIG. 10.

By using the method of FIG. 13, even in the case where only the one-direction adjustment function is provided, the antenna adjustment can be carried out with high precision.

Although the case of applying the one-directional adjustment approach of the decreasing direction to the antenna resonance adjustment has been described, the one-directional adjustment approach can be also applied to the other adjustment items as long as the method is an adjusting method having the one-direction adjusting function.

As described above, the wireless tag adjustment pattern is formed by ejecting the magnetic material, dielectric material, and conductive material by using the ink jet printer 37 on and around the wireless tag 1 in an actual use state in which the wireless tag 1 is adhered to the object 21 to be recognized. Consequently, without damaging the object 21 to be recognized to which the wireless tag 1 is attached, the impedance of the antenna 13 and the input impedance of the wireless IC chip 12 can be matched, and the half wavelength of the frequency of the high frequency current flowing in the antenna 13 and the length of the antenna 13 can be matched each other.

In addition, the accurate communication characteristic in the actual use state in which the wireless tag 1 is attached to the object 21 to be recognized can be measured. The antenna adjustment can be performed on each of the wireless tags 1 on the basis of the communication characteristic of the wireless tag 1. Since the adjustment pattern is formed by using the ink jet printer 37, the adjustment amount is small and almost stepless fine adjustment can be performed.

Further, measurement and adjustment can be repeatedly performed a plurality of times in short time on the wireless tag. Thus, the adjustment pattern can be approached to the optimum adjustment pattern while performing correction little by little, and high accuracy adjustment can be performed in short time. The method can be also applied to the object 21 to be recognized which is integrally formed with the wireless tag 1, or an object to be recognized which is difficult to be peeled.

### SECOND EMBODIMENT

A second embodiment relates to a technique of assuring the resonant condition by extending the length of the antenna 13 of the wireless tag 1 by using an ink jet printer. The same reference numerals are designated to the same parts as those of the foregoing embodiment and their detailed description will not be repeated. The configuration of a wireless tag adjustment system used in the second embodiment is basically similar to that of the first embodiment. The configuration shown in FIGS. 8 and 9 is used.

In the case of changing the length of the antenna, if the total change length is about, for example, 0.1 to 1 mm, the conductive material is ejected from the ink jet printer 37 to form a pattern so as to extend an end of the antenna 13, thereby enabling the antenna length to be changed. If the length is further increased, the resistance loss of the antenna increases.

In the case where the conductive material used to be ejected is metal particles whose component is platinum, gold, silver, copper, or the like, the conductivity of the entire antenna pattern becomes low without a heating process. In the case of using a conductive polymer (polyaniline, polypyrrole, polythiophene, polyisothianaphthene, polyethylene dioxithiophene, or the like), the conductivity of the conductor polymer itself is low.

To the conductive material, various addition agents are added to assure stable ejecting, and the resultant is generated as a solution ink similar to a printing ink.

In the case where the object to be recognized can endure the heating process and the soaking process, a conductor having sufficiently high conductivity can be formed, and the conductor part in the antenna can be extend to an arbitrary length.

In this case, a conductive paste containing metal particles is ejected onto the substrate 11 by the ink jet printer 37, and the metal particles are sintered at a temperature of about 200° C., thereby forming the conductive pattern that extends the length of the antenna. Alternatively, a conductive pattern for extending the length of the antenna is formed by ejecting a solution containing a catalyst for electroless plating onto the substrate 11 by the ink jet printer 37, and soaking the substrate 11 in an electroless plating chemical solution for performing electroless plating.

Therefore, the wireless tag adjusting system used in the second embodiment is obtained by adding the configuration of FIGS. 8 and 9 with a heating furnace for performing the heating process, an electroless plating bath for performing the soaking process or an apparatus for making only a conductor ejecting planned portion partially soaked in an electroless plating chemical solution, and the like.

In the case where the object to be recognized in the wireless tag adjusting system cannot endure the heating process and the soaking process, only the wireless tag is formed on the substrate and the resultant is adhered to the object to be recognized, thereby forming an object to be recognized with a wireless tag.

Next, formation of a conductor for extending the length of the antenna will be described.

FIG. 14 is a plan view showing an initial state viewed from above. FIGS. 15A and 15B, 16A and 16B, and 17A and 17B are enlarged views of the portion of a circle D in FIG. 14 and show formation of a conductor pattern for extending the antenna in an antenna left wing part at the time of extending the antenna in respective stages. FIGS. 15A, 16A, and 17A are plan views, and FIGS. 15B, 16B, and 17B are cross sections taken along lines E1-E1, E2-E2, and E3-E3 of FIGS. 15A, 16A, and 17A, respectively.

As shown in FIG. 14, a conductor ejecting planned portion 27 for antenna extension is assumed in each of portions extended from ends of both wing parts of the antenna 13. The conductor ejecting planned portion 27 for antenna extension is assumed on the control computer 42 but is not formed on the substrate 11. One or more conductor ejecting planned portions 27 is/are assumed so as to be continued to a conductor as a component of the antenna 13. In the embodiment, three conductor ejecting planned portions 27 for antenna extension are assumed for each of the both wings.

A solution containing a conductive material is ejected from the ink jet printer 37 to the conductor ejecting planned portions 27 for antenna extension, and antenna extension conductor patterns 28, 29, and 30 are formed step by step as shown in FIGS. 15A and 15B, 16A and 16B, and 17A and 17B, thereby electrically connecting a conductor having necessary length to the antenna 13 and extending the length of the antenna.

As shown in FIG. 14, the antenna 13 is bilaterally symmetrical. The length La0 of the antenna 13 in the initial state can be obtained by doubling a length, as a reference, obtained by adding the lengths of parts of one wing of the antenna 13. Specifically, when the lengths of parts of one wing are set as L0, H0, and L01 as shown in FIG. 14, La0=2×(L0+H0+L01).

As shown in FIGS. 15A and 15B, after the antenna extension conductor pattern 28 is formed as the first stage, the length La1 of the antenna 13 at the first stage is almost equal to 2×(L0+H0+2×L01) and is longer than the length La0 of the antenna in the initial state.

As shown in FIGS. 16A and 16B, after the antenna extension conductor pattern 29 is formed as the second stage, the length La2 of the antenna 13 at the second stage is almost equal to 2×(L0+H0+3×L01) and is longer than the length La1 of the antenna 13 in the first stage.

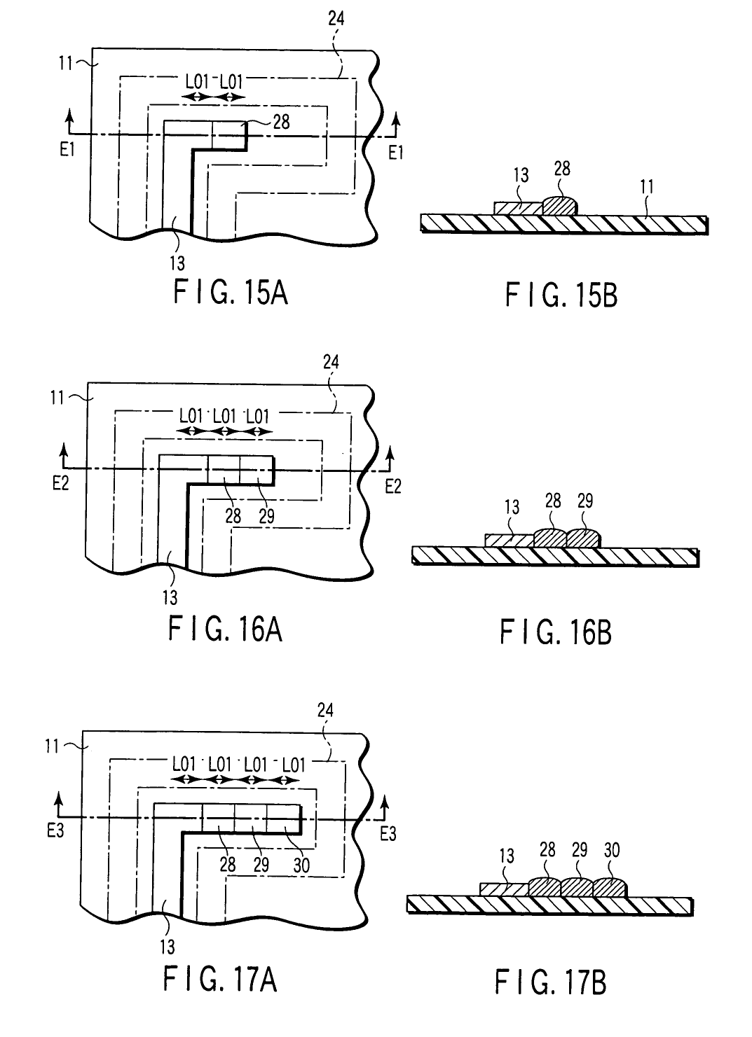

As shown in FIGS. 17A and 17B, after the antenna extension conductor pattern 30 is formed as the third stage, the length La3 of the antenna 13 at the third stage is almost equal to 2×(L0+H0+4×L01) and is longer than the length La2 of the antenna 13 in the second stage.

In such a manner, the length of the antenna 13 can be extended step by step. In the antenna extension conductor ejecting planned portion 27, the antenna extension conductor patterns 28, 29, and 30 can be formed in a small length unit such as 0.01 to 0.1 mm. Therefore, the antenna can be extended although stepwisely but which is almost like steplessly. Consequently, the length of the antenna can be made to coincide with the half wavelength of the frequency of the high frequency current flowing in the antenna with high precision.

Alternatively, by using the conductor material ejecting method and a low-resistivity conductor forming method to which the heating process and the soaking process are added, matching between the input impedance of the wireless IC chip 12 and the impedance of the antenna 13 can be obtained.

For example, by shortening the length of the slit, the inductance L for the slit 14 decreases, and the impedance of the antenna 13 decreases. By shortening the width of the slit, the capacitance C for the slit 14 increases, and the impedance of the antenna 13 decreases.

By using the method, the shortening dimension in the slit length and the slit width can be arbitrary selected in the range of, for example, 0.01 to 0.1 mm, so that the impedance of the antenna 13 can be adjusted with high precision.

### THIRD EMBODIMENT

A third embodiment relates to a technique of assuring the resonant condition by extending the length of the antenna 13 of the wireless tag 1 by using an ink jet printer. The same reference numerals are designated to the same parts as those of the foregoing embodiments and their detailed description will not be repeated. The configuration of a wireless tag adjustment system used in the third embodiment is basically similar to that of the first embodiment. The configuration shown in FIGS. 8 and 9 is used.

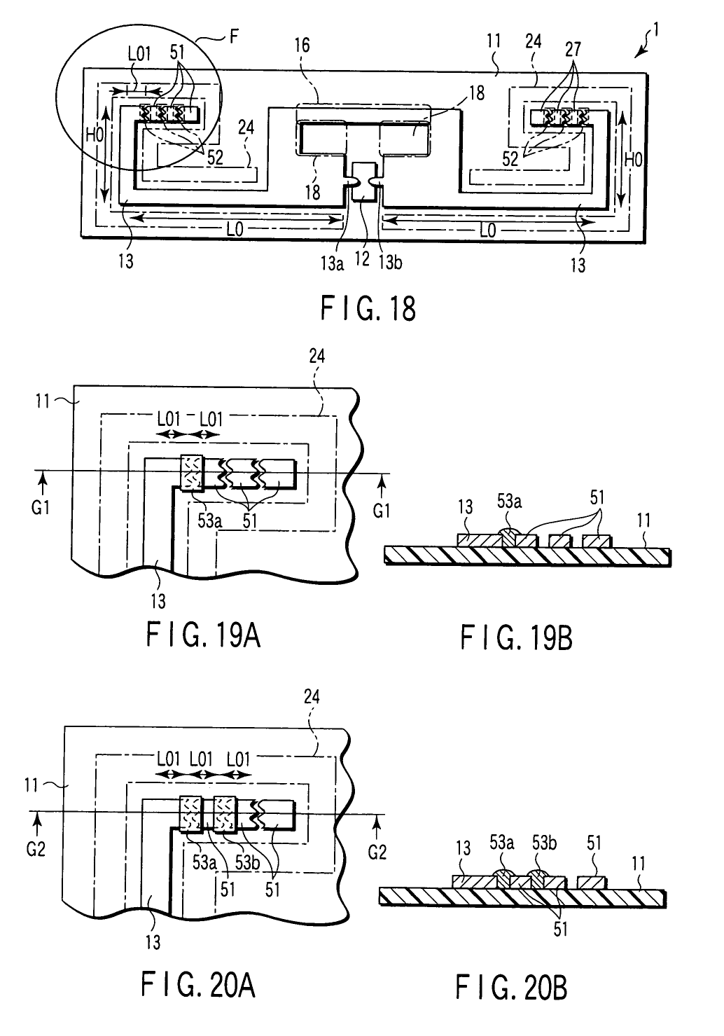

FIG. 18 is a plan view showing an initial state viewed from above. FIGS. 19A and 19B, FIGS. 20A and 20B, and FIGS. 21A and 21B are enlarged views of the portion of a circle F in FIG. 18 and show an antenna extension conductor patch 51 in an antenna left wing part at the time of extending the antenna in respective stages. FIGS. 19A, 20A, and 21A are plan views, and FIGS. 19B, 20B, and 21B are cross sections taken along lines G1-G1, G2-G2, and G3-G3 of FIGS. 19A, 20A, and 21A, respectively.

One or a plurality of the antenna extension conductor patches 51 are disposed at the tip of the antenna 13 in predetermined intervals and in series. For example, the antenna extension conductor patches 51 are disposed so as to be spaced from the antenna 13 and from each other every predetermined narrow interval of about, for example, 0.01 to 0.1 mm. Preferably, the antenna extension conductor patch 51 is the same as the conductive material forms the antenna 13 and is formed simultaneously with the antenna 13.

Portions covering the predetermined narrow intervals are antenna extension conductor ejecting planned portions 52. A solution containing a conductive material is ejected from the ink jet printer 37 to the conductor ejecting planned portions 52 to form the antenna extension conductor patterns 53, and necessary antenna extension conductor patches 51 are electrically connected, thereby extending the antenna length.

As shown in FIG. 18, the length La0 of the antenna 13 in the initial state can be obtained by doubling a length, as a reference, obtained by adding the lengths of parts of one wing of the antenna 13. Specifically, when the lengths of parts of one wing are set as L0, H0, and L01 as shown in FIG. 18, La0=2×(L0+H0+L01).

As shown in FIGS. 19A and 19B, after an antenna extension conductor pattern 53a is formed to extend the length to the first antenna extension conductor patch 51 as the first stage, the length La1 of the antenna 13 at the first stage is almost equal to 2×(L0+H0+2×L01) and is longer than the length La0 of the antenna in the initial state.

As shown in FIGS. 20A and 20B, after an antenna extension conductor pattern 53b is formed to extend the length to the second antenna extension conductor patch 51 as the second stage, the length La2 of the antenna 13 at the second stage is almost equal to 2×(L0+H0+3×L01) and is longer than the length La1 of the antenna 13 in the first stage.

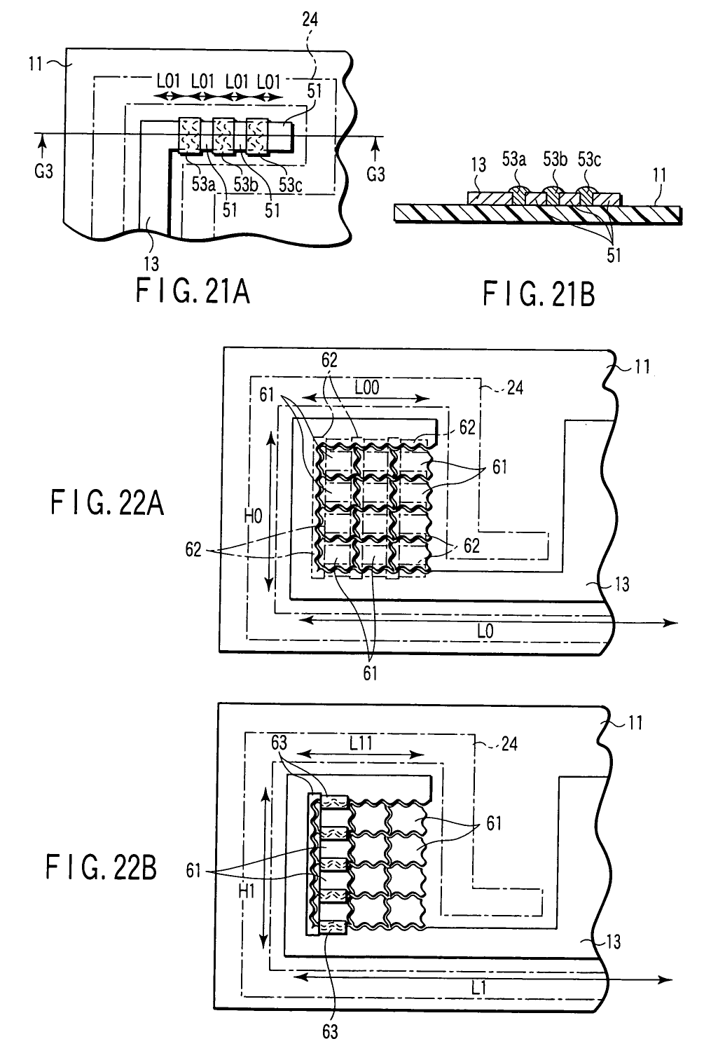

As shown in FIGS. 21A and 21B, after an antenna extension conductor pattern 53c is formed to extend the length to the third antenna extension conductor patch 51 as the third stage, the length La3 of the antenna 13 at the third stage is almost equal to 2×(L0+H0+4×L01) and is longer than the length La2 of the antenna 13 in the second stage.

In such a manner, the length of the antenna 13 can be extended step by step. The shape of the antenna extension conductor patch 51 for extending the length of the antenna 13 is not limited to the embodiment.

As the conductive material used to be ejected, metal particles whose component is platinum, gold, silver, copper, or the like or a conductive polymer (polyaniline, polypyrrole, polythiophene, polyisothianaphthene, polyethylene dioxithiophene, or the like) are used. To assure stable ejecting, various addition agents are added, and the resultant is generated as a solution ink which can be used like a printing ink.

The metal particles have low conductivity since they are not subjected to the heating process of 100 to 250° C. The conductivity of the conductive polymer is also low. When the conductivity is low, the resistance loss of the antenna is large and it is feared that sufficient energy to operate the wireless IC chip 12 cannot be supplied. Therefore, as shown in FIG. 18, the predetermined narrow intervals each being set to about 0.01 to 0.1 mm are formed so as to meander to increase the total extension length of the intervals. As a result, even if the conductivity of the conductive material burying the predetermined narrow interval is as low as, for example, 1 to 500 S/cm, the resistance value of the antenna 13 as a whole is suppressed.

Depending on the conditions, a drying process at a temperature at which the object 21 to be recognized is not damaged, for example, at 50° C. or less can be performed.

The conductive material of the antenna extension conductor patch 51 for extending the length of the antenna 13 is not limited to the same as the conductive material forms the antenna 13.

As described above, by using the antenna extension conductor patch 51, the length of the antenna 13 can be extended without damaging the object 21 to be recognized to which the wireless tag 1 is attached. In addition, the half wavelength of the frequency of the high frequency current flowing in the antenna 13 and the antenna length can be made to coincide with each other.

To prevent increase in resistance loss, the antenna extension conductor patch 51 needs the length of about, for example, 0.5 to 5 mm. Therefore, when the antenna length is made to coincide with the half wavelength of the frequency of the high frequency current flowing in the antenna 13, fine adjustment equal to or less than the length of the antenna extension conductor patch 51 cannot be performed. To solve the problem, it is sufficient to additionally use the wavelength shortening layer pattern 25.

To make the half wavelength of the frequency of the high frequency current flowing in the antenna 13 and the antenna length coincide with each other, the following method is executed.

First, the value of the maximum permittivity or the maximum permeability of the assumed object 21 to be recognized is used as a reference, and the half wavelength of the frequency of the high frequency current flowing in the antenna 13 is set as the initial value of the antenna length. The wireless tag 1 based on the initial value is generated and adhered to the object 21 to be recognized, or the wireless tag 1 is directly formed on the surface of the object 21 to be recognized. That is, the antenna 13 having the assumed minimum length is formed.

The value of the minimum permittivity or the minimum permeability of the assumed object 21 to be recognized is used as a reference, and the half wavelength of the frequency of the high frequency current flowing in the antenna 13 is set as a total antenna length obtained by adding the initial values of the antenna extension conductor patch 51 and the antenna length. The wireless tag 1 in which the antenna extension conductor patch 51 is formed based on the total antenna length is generated and adhered to the object 21 to be recognized, or the wireless tag 1 with the antenna extension conductor patch is directly formed on the surface of the object 21 to be recognized. That is, the extension conductor patch corresponding to the antenna having the assumed maximum length is formed.

The value of the maximum permittivity or the maximum permeability of an object to be recognized which is presently being adjusted is used as a reference, and the antenna length is calculated using, as a reference, the half wavelength of the frequency of the high frequency current flowing in the antenna 13. The number of extension conductor patches 51 to be connected is determined so that the length does not exceed the antenna length, and a solution containing the conductive material is ejected from the ink jet printer 37 to the antenna extension conductor ejecting planned portions 52 for connecting the patches, thereby forming the antenna extension conductor pattern 53. That is, the extension conductor patch corresponding to the antenna having the minimum length and closest to the object 21 to be recognized which is presently being adjusted is formed.

To the antenna portion and a wavelength shortening material ejecting planned portion 24 disposed around the antenna portion, a solution containing a dielectric material having required relative permittivity (for example, 1.1 to 100) or a solution containing a magnetic material having relative permeability (for example, 1.1 to 100) is ejected from the ink jet printer 37, thereby forming the wavelength shortening layer pattern 25. In such a manner, the wavelength of the high frequency current flowing in the antenna 13 is shortened. Finally, the half wavelength of the frequency of the high frequency current flowing in the antenna 13 and the antenna length are made to coincide with each other with high precision.

As described above, by using both the antenna extension conductor patches 51 and the wavelength shortening layer pattern 25 formed in the wavelength shortening material ejected planned portions 24, even when variations in the permittivity or permeability of the object 21 to be recognized are large, in a state where the wavelength shortening layer pattern 25 is maintained in thickness of about, for example, 0.1 to 1 mm, the half wavelength of the frequency of the high frequency current flowing in the antenna 13 and the antenna length can be made to coincide with each other with high precision without damaging the object 21 to be recognized to which the wireless tag 1 is attached. Therefore, the number of kinds of wireless tags initially manufactured can be suppressed. In addition, the wavelength shortening layer pattern 25 does not become thick, the total ejecting amount of each of various materials from the ink jet printer 37 can be reduced, and the antenna adjustment time can be shortened.

### FOURTH EMBODIMENT

A fourth embodiment relates to a technique of shortening the length of the antenna 13 of the wireless tag 1 by using an ink jet printer. The same reference numerals are designated to the same parts as those of the foregoing embodiments and their detailed description will not be repeated. The configuration of a wireless tag adjustment system used in the fourth embodiment is basically similar to that of the first embodiment. The configuration shown in FIGS. 8 and 9 is used.

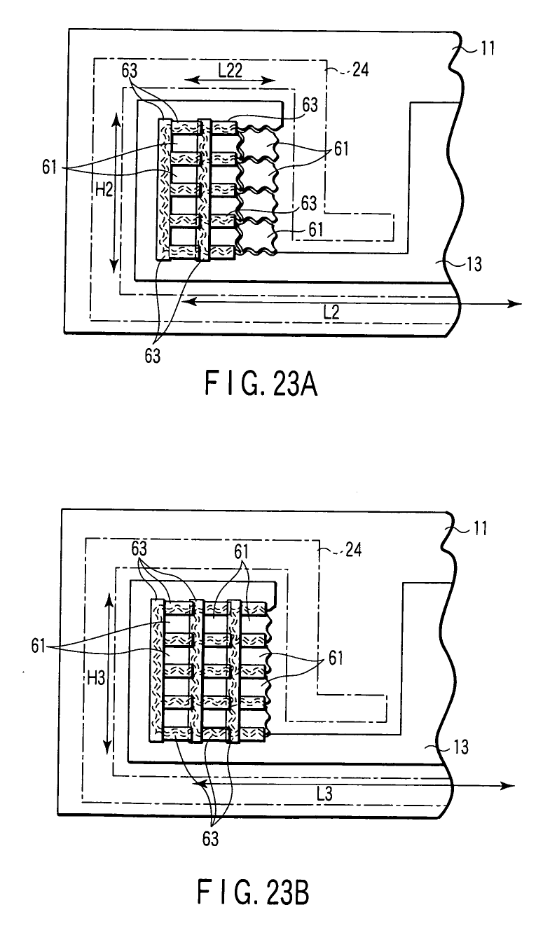

FIGS. 22A and 22B and FIGS. 23A and 23B are enlarged views of the portion of the wireless tag 1 and show an antenna shortening conductor patch 61 in an antenna left wing part at the time of extending the antenna in respective stages.

As shown in FIG. 22A, a plurality of antenna shortening conductor patches 61 are disposed in a portion bent in a U shape in the left wing of the antenna 13 in the vertical and horizontal directions so as to be spaced from the conductor of the antenna 13 and from each other every predetermined narrow interval of about, for example, 0.01 to 0.1 mm. The antenna shortening conductor patch 61 is the same as the conductor forms the antenna 13 and is formed simultaneously with the antenna 13.

Portions covering the predetermined narrow intervals are antenna shortening conductor ejecting planned portions 62. A solution containing a conductive material is ejected from the ink jet printer 37 to the antenna shortening conductor ejecting planned portions 62 to form the antenna shortening conductor patterns 63, and necessary antenna shortening conductor patches 61 are electrically connected, thereby shortening the antenna length.

As shown in FIG. 22A, length Lb0 of the antenna 13 in the initial state can be obtained by doubling a length, as a reference, obtained by adding the lengths of parts of one wing of the antenna 13. Specifically, when the lengths of parts of one wing are set as L0, H0, and L00 as shown in FIG. 22A, Lb0=2×(L0+H0+L00).

As shown in FIG. 22B, the antenna shortening conductor pattern 63 in the first line is formed and the antenna shortening conductor patch 61 in the first line is electrically connected to the antenna 13 to shorten the length of the antenna as the first stage. That is, when the antenna shortening conductor patch 61 in the first line is connected to the antenna 13, the length Lb1 of the antenna 13 becomes almost equal to 2×(L1+H1+2×L11). Since L1<L0 and L11<L00, the length Lb1 is shorter than the length Lb0 of the antenna 13 in the initial state.

As shown in FIG. 23A, the antenna shortening conductor pattern 63 in the second line is formed and the antenna shortening conductor patch 61 in the second line is electrically connected to the antenna shortening conductor patch 61 in the first line to thereby shorten the length of the antenna as the second stage. That is, when the antenna shortening conductor patch 61 in the second line is connected to the antenna shortening conductor patch 61 in the first line, the length Lb2 of the antenna 13 becomes almost equal to 2×(L2+H2+2×L22). Since L2<L1 and L22<L11, the length Lb2 is shorter than the length Lb1 of the antenna 13 in the first stage.

Further, as shown in FIG. 23B, the antenna shortening conductor pattern 63 in the third line is formed, and the antenna shortening conductor patch 61 in the third line is electrically connected to the antenna shortening conductor patch 61 in the second line to thereby further shorten the length of the antenna as the third stage. That is, when the antenna shortening conductor patch 61 in the third line is connected to the antenna shortening conductor patch 61 in the second line, the length Lb3 of the antenna 13 becomes almost equal to 2×(L3+H3). Since L3<L2 and L00=0, the length Lb3 is shorter than the length Lb2 of the antenna 13 in the second stage.

In such a manner, the length of the antenna 13 can be shortened step by step. The shape of the antenna shortening conductor patch 61 for shortening the length of the antenna 13 is not limited to the embodiment.

When the antenna shortening conductor patch 61 is used together with the wavelength shortening layer pattern 25, fine adjustment at the time of making the half wavelength of the frequency of the high frequency current flowing in the antenna 13 and the antenna length coincide with each other can be realized. Since the shortening of the antenna length and the shortening of the wavelength are directions opposite to each other, a bidirectional adjustment approach can be made.

To make the half wavelength of the frequency of the high frequency current flowing in the antenna 13 and the antenna length coincide with each other, the following method is executed.

First, the value of the average permittivity or the average permeability of the assumed object 21 to be recognized is used as a reference, and the half wavelength of the frequency of the high frequency current flowing in the antenna 13 is set as the initial value of the antenna length. The wireless tag 1 based on the initial value is generated and adhered to the object 21 to be recognized, or the wireless tag 1 is directly formed on the surface of the object 21 to be recognized. That is, the antenna 13 having the assumed average length is formed initially.

The value of the maximum permittivity or the maximum permeability of the assumed object 21 to be recognized is used as a reference, and the half wavelength of the frequency of the high frequency current flowing in the antenna 13 is set as a total antenna length obtained by adding the initial values of the antenna shortening conductor patch 61 and the antenna length. The wireless tag 1 in which the antenna shortening conductor patch 61 based on the total antenna length is generated and adhered to the object 21 to be recognized, or the wireless tag 1 with the antenna shortening conductor patch is directly formed on the surface of the object 21 to be recognized. That is, the pattern of the antenna shortening conductor patch corresponding to the antenna having the assumed minimum length is formed.

The value of the maximum permittivity or the maximum permeability of the object 21 to be recognized which is presently being adjusted is used as a reference, and the half wavelength of the frequency of the high frequency current flowing in the antenna 13 and the antenna length are calculated. The number of antenna shortening conductor patches 61 to be connected is determined so that the length does not exceed the antenna length, and a solution containing the conductive material is ejected from the ink jet printer 37 to the antenna shortening conductor ejecting planned portions 62 for connecting the patches, thereby forming the antenna shortening conductor pattern 63. In such a manner, the pattern of the antenna shortening conductor patch 61 corresponding to the antenna having the minimum length and closest to the object 21 to be recognized which is presently being adjusted is formed.

To the antenna portion and the wavelength shortening material ejecting planned portion 24 disposed around the antenna portion, a solution containing a dielectric material having required relative permittivity (for example, 1.1 to 100) or a solution containing a magnetic material having relative permeability (for example, 1.1 to 100) is ejected from the ink jet printer 37, thereby forming the wavelength shortening layer pattern 25. In such a manner, the wavelength of the high frequency current flowing in the antenna 13 is shortened. Finally, the half wavelength of the frequency of the high frequency current flowing in the antenna and the antenna length can be made to coincide with each other with high precision.

In the case where the length of the antenna 13 is excessively shortened in the connection with the antenna shortening conductor patch 61 due to an adjustment error or the like, it is sufficient to increase the thickness of the wavelength shortening layer pattern 25. On the contrary, in the case where the wavelength shortening layer pattern 25 is made too thick, it is sufficient to shorten the length of the antenna 13 in the connection with the antenna shortening conductor patch 61.

As described above, the bidirectional adjustment approach can be performed, so that speed and flexibility of the antenna adjustment increases.

By using both the antenna shortening conductor patches 61 and the wavelength shortening layer pattern 25 formed in the wavelength shortening material ejecting planned portions 24, even when variations in the permittivity or permeability of the object 21 to be recognized are large, the wavelength shortening layer pattern 25 can be thinned to, for example, about 0.1 to 1 mm, and the half wavelength of the frequency of the high frequency current flowing in the antenna and the antenna length can be made to coincide with each other with high precision without damaging the object 21 to be recognized to which the wireless tag 1 is attached. Therefore, the number of kinds of wireless tags initially manufactured can be suppressed. In addition, the wavelength shortening layer pattern 25 does not become thick, so that the total ejecting amount of each of various materials from the ink jet printer 37 can be reduced, and the antenna adjustment time can be shortened. The bidirectional adjustment approach can be realized, and the speed and flexibility of the antenna adjustment increases.

### FIFTH EMBODIMENT

A fifth embodiment relates to a technique of enabling the length of the antenna 13 of the wireless tag 1 to be changed so as to be both extended and shortened by using an ink jet printer. The same reference numerals are designated to the same parts as those of the foregoing embodiments and their detailed description will not be repeated. The configuration of a wireless tag adjustment system used in the fifth embodiment is basically similar to that of the first embodiment. The configuration shown in FIGS. 8 and 9 is used.

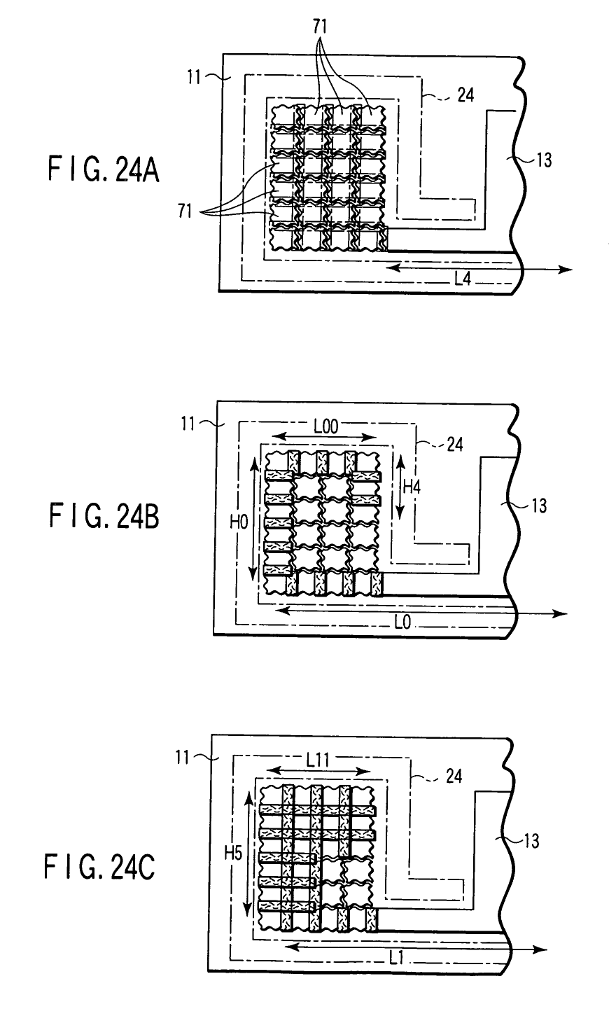

FIGS. 24A to 24C are enlarged views of the portion of the wireless tag 1. FIG. 24A shows an initial state before an antenna length changing conductor patch 71 is connected. FIG. 24B shows a state in which the antenna length changing conductor patch 71 is electrically connected, and the length of the antenna is extended. FIG. 24C shows a state in which the length of the antenna extended once is shortened by further electrically connecting the antenna length changing conductor patch 71.

As shown in FIG. 24A, the antenna length changing conductor patch 71 is obtained by two-dimensionally arranging conductor patches in a lattice shape from a linear portion of the antenna 13. A plurality of antenna length changing conductor patches 71 are disposed so as to be spaced from the conductor of the antenna 13 and from each other every predetermined narrow interval of about, for example, 0.01 to 0.1 mm. The antenna length changing conductor patch 71 is the same as the conductor that forms the antenna 13.

Portions covering the predetermined narrow intervals are antenna length changing conductor ejecting planned portions 72. A solution containing a conductive material is ejected from the ink jet printer 37 to the antenna length changing conductor ejecting planned portions 72 to form the antenna length changing conductor patterns 73, and the antenna length is changed.

As shown in FIG. 24A, the length Lc0 of the antenna 13 in the initial state can be obtained by doubling a length, as a reference, obtained by adding the lengths of parts of one wing of the antenna 13. Specifically, when the length of one wing is set as L4, Lc0=2×L4.

As shown in FIG. 24B, when the antenna length changing conductor pattern 73 is formed and the tips of both wings of the antenna 13 are extended so as to wind by the antenna length changing conductor patch 71 as the first stage, the length Lc1 of the antenna 13 at the first stage is almost equal to 2×(L0+H0+L00+H4) and becomes sufficiently longer than the length Lc0 of the antenna 13 in the initial state.

As shown in FIG. 24C, in the second stage, when the antenna length changing conductor patches 71 in the portion surrounded by the antenna length changing conductor patches 71 connected in the first stage are connected by forming the antenna length changing conductor pattern 73, the length Lc2 of the antenna 13 at the second stage is almost equal to 2×(L1+H5+L11). Since L11<L00 and H4=0, the length Lc2 is made shorter than the length Lc1 of the antenna 13 in the first stage.

In such a manner, the length of the antenna 13 can be changed to be increased/decreased step by step. The connection pattern that changes the length of the antenna is not limited to the pattern shown in FIGS. 24B and 24C.

In the antenna length changing conductor patch 71, when the wavelength shortening layer pattern 25 formed in the wavelength shortening material ejecting planned portion 24 shown in FIG. 24 is also used, matching between the half wavelength of the frequency of the high frequency current flowing in the antenna and the antenna length can be finely adjusted. Further, since the shortening of the length of the antenna 13 and the shortening of the wavelength are directions opposite to each other, a bidirectional adjustment approach can be made. Extension of the antenna 13 can be also performed. Therefore, the pattern made by the antenna length changing conductor patches 71 has both the functions and effects of the pattern made by the antenna extending conductor patches 51 and the pattern made by the antenna shortening conductor patches 61. Thus, the speed and flexibility of antenna adjustment can be further improved.

### SIXTH EMBODIMENT

A sixth embodiment relates to a technique of obtaining matching between the impedance of the antenna 13 and the input impedance of the wireless IC chip 12 by deforming the shape of the slit 14 in the wireless tag 1. The same reference numerals are designated to the same parts as those of the foregoing embodiments and their detailed description will not be repeated. The configuration of a wireless tag adjustment system used in the sixth embodiment is basically similar to that of the first embodiment. The configuration shown in FIGS. 8 and 9 is used.

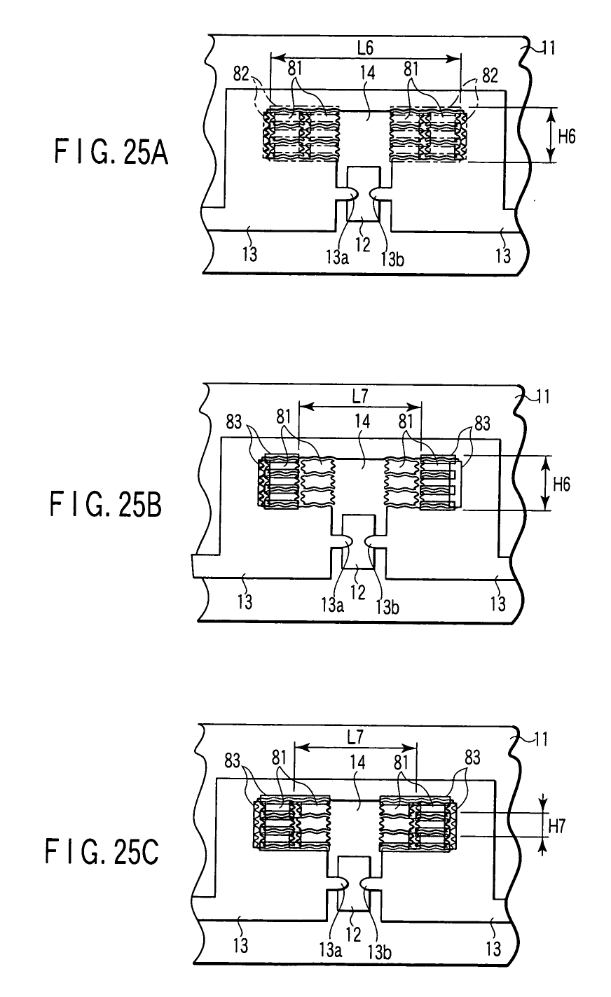

FIGS. 25A to 25C are enlarged views of the portion in which the slit 14 is formed in the wireless tag 1. FIG. 25A shows an initial state before a slit deforming conductor patch 81 is connected. FIG. 25B shows a first stage in which the slit deforming conductor patches 81 are electrically connected and the length of the slit is shortened. FIG. 25C shows a second stage in which the slit deforming conductor patches 81 are further electrically connected and the width of the slit is shortened.

As shown in FIG. 25A, the slit deforming conductor patches 81 are obtained by two-dimensionally arranging conductor patches in a lattice shape for the slit 14. A plurality of slit deforming conductor patches 81 are disposed so as to be spaced from the conductor of the antenna 13 and from each other every predetermined narrow interval of about, for example, 0.01 to 0.1 mm. The slit deforming conductor patch 81 is the same as the conductor that forms the antenna 13.

Portions covering the predetermined narrow intervals are slit deforming conductor ejecting planned portions 82. A solution containing a conductive material is ejected from the ink jet printer 37 to the slit deforming conductor ejecting planned portions 82 to form the slit deforming conductor patterns 83, and the slit is deformed.

As shown in FIG. 25A, in the initial state, the slit length Ls0=L6, and the slit width Hs0=H6. When the slit deforming conductor pattern 83 is formed and the slit deforming conductor patches 81 in the fist line are connected to the antenna 13 as the first stage, only the slit length is shortened as shown in FIG. 25B. The slit length Ls1 at the first stage is L7 (<L6), and the slit width Hs1 remains as H6.

As the second stage, the slit deforming conductor pattern 83 is formed and the top and bottom slit deforming conductor patches 81 in the second line are connected to the antenna 13 and the slit deforming conductor patches 81 in the first line, only the slit width is shortened. Although the slit length Ls2 at the second stage remains as L7, the slit width Hs2 is shortened to H7 (<H6). In such a manner, the slit shape can be changed step by step. The connection pattern for changing the shape of the slit is not limited to the patterns shown in FIGS. 25B and 25C.

The slit 14 forms a distributed constant circuit in cooperation with the conductor of the antenna 13 around the slit 14 and the substrate 11. For example, the inductance L exists in the antenna portion along the slit length and in the periphery of the antenna portion, and a capacitance C exists in the portion of the substrate 11 corresponding to the slit width and the periphery of the portion. Matching between the input impedance of the wireless IC chip 12 and the impedance of the antenna 13 is obtained by adjusting the impedance of the antenna 13 by the following method.

As shown in FIG. 25B, when the slit length is shortened, the inductance L in the slit 14 decreases, and the impedance of the antenna 13 decreases. As shown in FIG. 25C, when the slit width is shortened, the capacitance C in the slit 14 increases, and the impedance in the antenna 13 decreases.

Since the slit deforming conductor patches 81 can change the shape of the slit 14 step by step, when a large adjustment amount is necessary, the adjustment time is shortened. However, the direction of the impedance adjustment of the slit deforming conductor patch 81 is only one direction of decreasing the impedance of the antenna 13 and, moreover, the impedance is decreased step by step. Consequently, it is preferable that bidirectional operations of increasing or decreasing the impedance of the antenna 13 can be performed, and both formation of the magnetic pattern 17 and the dielectric pattern 19 capable of realizing a fine adjustment amount and change in the shape of the slit 14 by the slit deforming conductor patches 81 can be used. As a result, the speed and flexibility of the impedance matching increases.

In the case where the object 21 to be recognized can endure a heating process and a soaking process, the conductor portion of the antenna 13 can be formed from the initial state by using the wireless tag adjusting system. In this case, the wireless tag adjusting system is obtained by adding a heating furnace for performing the heating process, an electroless plating bath for performing the soaking process, an apparatus for making only a conductor ejecting planned portion partially soaked in an electroless plating chemical solution, and the like.

In the case where the object 21 to be recognized in the wireless tag adjusting system cannot endure the heating process and the soaking process, only the wireless tag is formed on the substrate 11 and the resultant is adhered to the object 21 to be recognized, thereby forming an object to be recognized with a wireless tag.

The wireless tag adjusting system can be also used as a system of adjusting only a wireless tag which is not adhered to the object 21 to be recognized. In this case, adjustment data is collected in a state where a wireless tag is adhered to an object to be recognized which is assumed as an actual use state. On the basis of the adjustment data, a solution ink containing a conductor material, a solution ink containing a dielectric material, and a solution ink containing a magnetic material are ejected, thereby performing initial formation and adjustment of an antenna. Therefore, high-speed and accurate adjustment can be performed also on only the wireless tag.

By ejecting the conductive material from the ink jet printer 37 and electrically connecting the wireless IC chip 12 as an integrated circuit and the antenna 13 to each other, the wireless IC chip 12 as an integrated circuit can be mounted on the wireless tag 1. By ejecting a semiconductor material from the ink jet printer 37 and performing a necessary heating process and the like, the wireless IC chip 12 can be directly formed on the substrate 11 or the object 21 to be recognized.

In this case, since no data is written in the wireless IC chip 12 mounted or formed, at the time of writing data, a device for writing data to a wireless tag is added to the wireless tag adjusting system.

The wireless tag adjusting system also has a drive circuit of the ink jet printer 37, so that an ink jet head for writing an image can be also mounted. In this case, an image or message can be written on the wireless tag 1 and the object 21 to be recognized. For example, a bar code, adjustment data, adjustment year/month/date, and information in the wireless tag for recognizing the object 21 to be recognized can be printed so that the wireless tag adjusting system can be used in various sites such as the end, an intermediate point, or the like of a commodity flow.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by appended claims and their equivalents.

What is claimed is:

1. A wireless tag adjusting method comprising:
measuring a communication characteristic by performing wireless communication with a wireless tag having an antenna and an integrated circuit connected to the antenna;
calculating an antenna adjustment pattern on the basis of the measured communication characteristic; and
forming an adjustment pattern by one of or a combination of ejecting of a dielectric material, ejecting of a magnetic material, and ejecting of a conductive material by using an ink jet printer on and/or around the antenna in the wireless tag in accordance with the calculated antenna adjustment pattern, thereby adjusting the antenna in the wireless tag.

2. The wireless tag adjusting method according to claim 1, wherein in a state where the wireless tag is attached to an object to be recognized via a substrate for mounting the wireless tag or directly, the communication characteristic is measured by performing wireless communication with the wireless tag.

3. A wireless tag adjusting system comprising:
an object to be recognized to which a wireless tag having an antenna and an integrated circuit connected to the antenna is connected via a substrate for mounting the wireless tag or directly;
communication characteristic measuring unit configured to measure a communication characteristic by performing wireless communication with the wireless tag;
adjustment pattern calculating unit configured to calculate an antenna adjustment pattern on the basis of the communication characteristic measured by the communication characteristic measuring unit; and
ink jet printer configured to print an adjustment pattern by one of or a combination of ejecting of a dielectric material, ejecting of a magnetic material, and ejecting of a conductive material on and/or around the antenna in the wireless tag in accordance with the antenna adjustment pattern calculated by the adjustment pattern calculating unit.

4. The wireless tag adjusting system according to claim 3, wherein a second antenna equipped in the communication characteristic measuring unit and the ink jet printer selectively face the wireless tag.

5. A wireless tag comprising:
an antenna disposed on a substrate;
an integrated circuit connected to the antenna and disposed on the substrate; and
an antenna adjustment pattern formed by one of or a combination of a dielectric material, a magnetic material, and a conductive material on the antenna and/or the substrate around the antenna.

6. The wireless tag according to claim 5, wherein the substrate is a part of an object to be recognized to the wireless tag.

7. The wireless tag according to claim 5, wherein a slit that forms an impedance matching circuit is provided on the antenna connected to the integrated circuit, and an antenna adjustment pattern is formed of a dielectric material in the slit portion.

8. The wireless tag according to claim 6, wherein a slit that forms an impedance matching circuit is provided on the antenna connected to the integrated circuit, and an antenna adjustment pattern is formed of a dielectric material in the slit portion.

9. The wireless tag according to claim 5, wherein a slit that forms an impedance matching circuit is provided on the antenna connected to the integrated circuit, and an antenna adjustment pattern is formed of a magnetic material on the antenna in the periphery of the slit.

10. The wireless tag according to claim 6, wherein a slit that forms an impedance matching circuit is provided on the antenna connected to the integrated circuit, and an antenna adjustment pattern is formed of a magnetic material on the antenna in the periphery of the slit.

11. The wireless tag according to claim 5, wherein one or a plurality of conductor patches each having a predetermined size is/are disposed so as to be spaced from the antenna and from neighboring conductor patches every predetermined interval at an end of the antenna or on the substrate in the periphery, and
a conductor pattern is selectively formed in the interval with the antenna or in both of the interval with the antenna and the interval with the neighboring conductor patch, thereby adjusting the length of the antenna.

12. The wireless tag according to claim 11, wherein one or a plurality of conductor patches include the same conductor as that of the antenna.

13. The wireless tag according to claim 11, wherein one or a plurality of conductor patches are disposed in series so as to be spaced from the antenna and from neighboring conductor patches every predetermined interval at an end of the antenna.

14. The wireless tag according to claim 11, wherein a plurality of conductor patches are two-dimensionally arranged in a lattice shape so as to be spaced from the antenna and the neighboring conductor patches every predetermined interval.

15. The wireless tag according to claim 11, wherein a slit that forms an impedance matching circuit is provided on the antenna connected to the integrated circuit, and one or a plurality of conductor patches are disposed in the slit so as to be spaced from the antenna and from neighboring conductor patches every predetermined interval.
